(19) United States
(12) Patent Application Publication
(10) Pub. No.: US 2020/0353896 A1
(43) Pub. Date: Nov. 12, 2020

(54) VEHICLE WIPER DEVICE AND VEHICLE WIPER DEVICE CONTROL METHOD

(71) Applicant: DENSO CORPORATION, Kariya-shi, Aichi (JP)

(72) Inventors: Norihiro SUGIMOTO, Toyohashi-city (JP); Atsushi KATO, Toyohashi-city (JP)

(73) Assignee: DENSO CORPORATION, Kariya-shi, Aichi (JP)

(21) Appl. No.: 16/467,568

(22) PCT Filed: Dec. 1, 2017
(86) PCT No.: PCT/JP2017/043326

§ 371 Date: Jun. 7, 2019

(30) Foreign Application Priority Data
Dec. 12, 2016 (JP) 2016-240533
Dec. 12, 2016 (JP) 2016-240534

(51) Int. Cl. B60S 1/04; B60S 1/24; B60S 1/08

(52) U.S. Cl. CPC B60S 1/0452; B60S 1/0833; B60S 1/245

(57) ABSTRACT

A vehicle wiper device is provided including a first motor that swings a wiper arm such that a wiper blade coupled to a leading end portion of the wiper arm wipes a windshield, a second motor that extends or retracts an extension and retraction mechanism provided to the wiper arm in order to change a wiping range of the wiper blade, and a controller that controls rotation of the first motor such that the first motor rotates at a rotation speed corresponding to a wiping speed, and that controls rotation of the second motor so as to extend or retract the extension and retraction mechanism by an extension or retraction amount corresponding to the wiping speed during a wiping operation.

### TECHNICAL FIELD

The present disclosure relates to a vehicle wiper device capable of changing a wiping range, and a control method for the vehicle wiper device.

### BACKGROUND ART

In vehicle wiper devices that wipe automobile windshield glass or the like, a wiper arm to which a wiper blade is attached is operated to-and-fro between a lower return position and an upper return position by a wiper motor. The trajectory of the wiper arm operation is frequently a substantially circular are shape centered on a pivot shaft of the wiper arm. Accordingly, a wiping range configuring a region of the windshield glass or the like wiped by the wiper blade has a substantially fan shape centered on the pivot shaft.

It is necessary for vehicle wiper devices to prioritize wiping of the windshield glass on a drivers seat side in order to secure the field of view of the driver. Automobile windshield glass has a substantially isosceles trapezoidal shape. Accordingly, in parallel (tandem) wiper devices in which two wiper arms pivot in the same direction at the same time as each other, if the pivot shaft is provided below the windshield glass, the upper return position of the wiper blade on the driver's seat side is provided at a position close to and parallel to the driver's seat side edge of the substantially isosceles trapezoidal shaped windshield glass (an upward direction edge of the isosceles trapezoidal shape).

The upper return position of a from passenger seat side wiper blade of a tandem wiper device is likewise provided parallel to the driver's seat side edge of the windshield glass in order to prioritize wiping of the windshield glass on the driver's seat side. However, as described above, since the wiping range of the wiper blade has a substantially fan shape, if the upper return positions are provided at the positions described above, a non-wiped region arises centered on an upper corner on the front passenger seat side of the windshield glass.

Japanese Patent Application Laid-Open (JP-A) No. H11-227572 discloses a wiper device in which a wiping range on a front passenger seat side of windshield glass is changed by appearing to extend the overall length of a wiper arm during operation by configuring a link mechanism of the wiper device by what is referred to as a four-bar linkage.

As illustrated in FIG. 16, in the wiper device described in JP-A No. H11-227572, a front passenger seat side wiper blade 154P wipes a wiping range Z12 between a lower return position P4P and an upper return position P3P by transmitting drive force from a motor to a front passenger seat wiper arm 150P through a four-bar linkage 160. In FIG. 16, a wiping range Z10 is a wiping range of a wiper device that does not include the four-bar linkage 160 and in which a wiper arm is operated centered on a pivot shaft. As illustrated in FIG. 16, the wiper device described in JP-A No. H11-227572 is capable of wiping to a portion closer to an upper corner on the front passenger seat side of a windshield glass 1 than the wiper device that does not include the four-bar linkage 160.

### SUMMARY OF INVENTION

### Technical Problem

However, even with the wiper device described in JP-A No. H11-227572, as illustrated in FIG. 16, the extension of the front passenger seat wiper arm during operation is insufficient, resulting in a non-wiped range 158 that remains unwiped at an upper portion on the front passenger seat side of the windshield glass. Moreover, in the wiper device described in JP-A No. H11-227572, swinging of the from passenger seat wiper arm 150P and extension of the from passenger seat wiper arm 150P are performed using a single motor. As a result, the trajectory of the front passenger seat wiper arm 150P is preordained and the trajectory of the front passenger seat wiper arm 150P cannot be changed.

Moreover, as illustrated in FIG. 26, in a vehicle wiper device disclosed in JP-A No. 2005-206032, wiping ranges 156D, 156P configuring regions of a windshield glass 1 or the like wiped by wiper blades 154D, 154P each have a substantially fan shape centered on pivot shafts 152D, 152P. As a result, a non-wiped range 158 that is not wiped by the wiper blade 154P arises centered on a corner 1C of an upper portion on the front passenger seat side of the windshield glass 1.

Water droplets are liable to collect in the non-wiped range 158 on an outward journey of the wiper blade 154P from the lower return position P4P toward the upper return position P3P. Water droplets that have collected in the non-wiped range 158 flow downward into the wiped range 156P, causing what are referred to as rain trickles. Such rain trickles not only affect the field of view of the driver, but could also cause incorrect operation of a water droplet detection sensor used to detect a change amount in water droplets adhering to the windshield glass.

The present disclosure provides a vehicle wiper device that adjusts a level of change of a wiping range according to circumstances, and a control method for the vehicle wiper device.

### Solution to Problem

A vehicle wiper device of a first aspect of the present disclosure includes a first motor that swings a wiper arm such that a wiper blade coupled to a leading end portion of the wiper arm wipes a windshield, a second motor that extends or retracts an extension and retraction mechanism provided to the wiper arm in order to change a wiping range of the wiper blade, and a controller that controls rotation of the first motor such that the first motor rotates at a rotation speed corresponding to a wiping speed, and that controls rotation of the second motor so as to extend or retract the extension and retraction mechanism by an extension or retraction amount corresponding to the wiping speed during a wiping operation.

In the vehicle wiper device of the first aspect, rotation of the second motor is controlled so as to be synchronized with rotation of the first motor. In this control, the extension and retraction mechanism is extended or retracted to change the wiping range of the windshield by the wiper blade. The wiping range is changed by the extension and retraction mechanism so as to correspond to the wiping speed, thereby enabling the level of change of the wiping range to be adjusted according to circumstances.

A vehicle wiper device of a second aspect of the present disclosure is the first aspect, wherein the controller sets the wiping speed to a low speed or a high speed according to external circumstances.

The second aspect enables the change to the wiping range by the extension and retraction mechanism to be made to reflect circumstances outside the vehicle.

A vehicle wiper device of a third aspect of the present disclosure is the second aspect, wherein the external circumstances include an amount of water on the windshield.

The third aspect enables the change to the wiping range of the windshield by the wiper blade to be controlled based on the amount of water on the windshield.

A vehicle wiper device of a fourth aspect of the present disclosure is any one of the first aspect to the third aspect, wherein in cases in which the wiping speed is a low speed, the controller controls such that an extension amount of the extension and retraction mechanism is at a maximum when the wiper blade wipes a portion corresponding to an upper corner of the windshield. In cases in which the wiping speed is a high speed, the controller controls such that an extension amount of the extension and retraction mechanism when the wiper blade wipes the portion corresponding to the upper corner is smaller than the extension amount at the low speed, and such that an extension amount of the extension and retraction mechanism is at a maximum when the wiper blade is positioned between the portion corresponding to the upper corner and an upper return position.

In the vehicle wiper device of the fourth aspect, in cases in which the wiping speed is a low speed, the extension and retraction mechanism is operated such that the upper corner on a front passenger seat side of the windshield is wiped, thereby enabling the field of view in a left-right direction to be secured. In cases in which the wiping speed is a high speed, the extension amount of the extension and retraction mechanism is at a maximum at an upper portion of the windshield including the upper return position. Thus, for example, if an onboard sensor (a sensor that senses raindrops or monitors ahead of the vehicle) is provided at the upper portion of the windshield, the wiping range can be changed such that a sensing range of the onboard sensor is wiped.

A vehicle wiper device of a fifth aspect of the present disclosure is the fourth aspect, wherein in cases in which the wiping speed is a high speed, the controller controls such that an extension amount of the extension and retraction mechanism is at a maximum when the wiper blade is positioned in the vicinity of the upper return position.

In the vehicle wiper device of the fifth aspect, in cases in which the wiping speed is a high speed, the extension and retraction mechanism is operated such that the wiping range is changed at the upper portion of the windshield including the upper return position. Thus, for example, if an onboard sensor (a sensor that senses raindrops or monitors ahead of the vehicle) is provided at the upper portion of the windshield, a sensing range of the onboard sensor can be wiped, even in cases in which the wiping speed is a high speed.

A vehicle wiper device of a sixth aspect of the present disclosure is the fifth aspect, wherein in cases in which the wiping speed is a high speed, the controller controls so as to reverse a direction of the wiper blade at the upper return position while the second motor is in a driven state.

In the vehicle wiper device of the sixth aspect, the wiper blade is reversed in direction at the upper return position while the second motor is in a driven state, thereby enabling the windshield glass to be wiped while the extension and retraction mechanism is in an extended state at the upper return position.

A vehicle wiper device of a seventh aspect of the present disclosure is any one of the first aspect to the sixth aspect, wherein the controller controls rotation of the first motor and the second motor so as to project a rubber leading end portion of the wiper blade outside an outer edge portion of an upper portion of the windshield when the rubber leading end portion wipes a portion corresponding to the outer edge portion.

The vehicle wiper device of the seventh aspect enables rain to be prevented from trickling into the wiping range by making the wiper blade wipe beyond the outer edge portion of the windshield glass.

A vehicle wiper device of an eighth aspect of the present disclosure is the seventh aspect, wherein the controller controls so as to project the rubber leading end portion outside the outer edge portion at an upper portion side of the windshield, and so as not to project to the rubber leading end portion outside the outer edge portion at a side portion side of the windshield.

In the vehicle wiper device of the eighth aspect, the rubber leading end portion is made to project outside the outer edge portion at the upper portion side of the windshield, thereby preventing rain from trickling into the wiping range. The rubber leading end portion is also controlled so as not to project outside the outer edge portion at the side portion side of the windshield, thereby preventing the rubber leading end portion from projecting out in the vehicle width direction.

A vehicle wiper device of a ninth aspect of the present disclosure is the seventh aspect or the eighth aspect, wherein when stopping the wiper blade at a lower return position, the controller controls rotation of the first motor and the second motor so as to project the rubber leading end portion outside the outer edge portion during a wiping operation in a direction toward the lower return position after the wiper blade has been reversed in direction at an upper return position.

In the vehicle wiper device of the ninth aspect, in the wiping operation from the upper return position toward the lower return position directly prior to completing a wiping operation, the wiper blade is made to wipe beyond the outer edge portion of the windshield glass, thereby enabling rain to be prevented from trickling into the wiping range.

A vehicle wiper device control method of a tenth aspect of the present disclosure includes swinging a wiper arm such that a wiper blade coupled to a leading end portion of the wiper arm wipes a windshield, extending or retracting an extension and retraction mechanism provided to the wiper arm in order to change a wiping range of the wiper blade, and extending or retracting the extension and retraction mechanism by an extension or retraction amount corresponding to a wiping speed during a wiping operation.

In the tenth aspect, the wiping range is changed by the extension and retraction mechanism so as to correspond to the wiping speed, thereby enabling the level of change of the wiping range to be adjusted according to circumstances.

A vehicle wiper device control method of an eleventh aspect of the present disclosure is the tenth aspect, further including setting the wiping speed to a low speed or a high speed according to external circumstances.

The eleventh aspect enables the change to the wiping range by the extension and retraction mechanism to be made to reflect circumstances outside the vehicle.

A vehicle wiper device control method of a twelfth aspect of the present disclosure is the eleventh aspect, wherein the external circumstances include an amount of water on the windshield.

The twelfth aspect enables the change to the wiping range of the windshield by the wiper blade to be controlled based on the amount of water on the windshield.

A vehicle wiper device control method of a thirteenth aspect of the present disclosure is any one of the tenth aspect to the twelfth aspect, wherein in cases in which the wiping speed is a low speed, an extension amount of the extension and retraction mechanism is at a maximum when the wiper blade wipes a portion corresponding to an upper corner of the windshield. In cases in which the wiping speed is a high speed, an extension amount of the extension and retraction mechanism when the wiper blade wipes the portion corresponding to the upper corner is smaller than the extension amount at the low speed, and an extension amount of the extension and retraction mechanism is at a maximum when the wiper blade is positioned between the portion corresponding to the upper corner and an upper return position.

In the vehicle wiper device control method of the thirteenth aspect, in cases in which tire wiping speed is a low speed, the extension and retraction mechanism is operated such that the upper corner on a front passenger seat side of the windshield is wiped, thereby enabling the field of view in the left-right direction to be secured. In cases in which the wiping speed is a high speed, the extension amount of the extension and retraction mechanism is at a maximum at an upper portion of the windshield including the upper return position. Thus, for example, if an onboard sensor (a sensor that senses raindrops or monitors ahead of the vehicle) is provided at the upper portion of the windshield, the wiping range can be changed such that a sensing range of the onboard sensor is wiped.

A vehicle wiper device control method of a fourteenth aspect of the present disclosure is the thirteenth aspect, wherein in cases in which the wiping speed is a high speed, an extension amount of the extension and retraction mechanism is at a maximum when the wiper blade is positioned in the vicinity of the upper return position.

In the fourteenth aspect, in cases in which the wiping speed is a high speed, the extension and retraction mechanism is operated such that the wiping range is changed at the upper portion of the windshield including the upper return position. Thus, for example, if an onboard sensor (a sensor that senses raindrops or monitors ahead of the vehicle) is provided at the upper portion of the windshield, a sensing range of the onboard sensor can be wiped, even in cases in which the wiping speed is a high speed.

A vehicle wiper device control method of a fifteenth aspect of the present disclosure is the fourteenth aspect, wherein in cases in which the wiping speed is a high speed, the wiper blade is controlled so as to be reversed in direction at the upper return position while the second motor is in a driven state.

In the fifteenth aspect, the wiper blade is reversed in direction at the upper return position while the second motor is in a driven state, thereby enabling the windshield glass to be wiped while the extension and retraction mechanism is in an extended state at the upper return position.

A vehicle wiper device control method of a sixteenth aspect of the present disclosure is any one of the tenth aspect to the fifteenth aspect, wherein a rubber leading end portion of the wiper blade is projected outside an outer edge portion of an upper portion of the windshield when the rubber leading end portion wipes a portion corresponding to the outer edge portion.

The sixteenth aspect enables rain to be prevented from trickling into the wiping range by making the wiper blade wipe beyond the outer edge portion of the windshield glass.

A vehicle wiper device control method of a seventeenth aspect of the present disclosure is the sixteenth aspect, wherein the rubber leading end portion is projected outside the outer edge portion on an upper portion side of the windshield, and is not projected outside the outer edge portion on a side portion side of the windshield.

In the seventeenth aspect, the rubber leading end portion is projected outside the outer edge portion at the upper portion side of the windshield, thereby prevailing rain from trickling into the wiping range. The rubber leading end portion is also controlled so as not to project outside the outer edge portion at the side portion side of the windshield, thereby preventing the rubber leading end portion from projecting out in the vehicle width direction.

A vehicle wiper device control method of an eighteenth aspect of the present disclosure is either the sixteenth aspect or the seventeenth aspect, wherein when stopping the wiper blade at a lower return position, the rubber leading end portion is projected outside the outer edge portion during a wiping operation in a direction toward the lower return position after the wiper blade has been reversed in direction at an upper return position.

In the eighteenth aspect, in the wiping operation from the upper return position toward the lower return position directly prior to completing a wiping operation, the wiper blade is made to wipe beyond the outer edge portion of the windshield glass, thereby enabling rain to be prevented from trickling into the wiping range.

### BRIEF DESCRIPTION OF DRAWINGS

FIG. 1 is a schematic diagram illustrating an example of a vehicle wiper system including a vehicle wiper device according to a first exemplary embodiment of the present disclosure.

FIG. 2 is a plan view of a vehicle wiper device according to the first exemplary embodiment in a stationary state.

FIG. 3 is a cross-section of a second holder member sectioned along line A-A in FIG. 2.

FIG. 4 is a plan view of a vehicle wiper device according to the first exemplary embodiment during operation.

FIG. 5 is a plan view of a vehicle wiper device according to the first exemplary embodiment during operation.

FIG. 6 is a plan view of a vehicle wiper device according to the first exemplary embodiment during operation.

FIG. 7 is a plan view of a vehicle wiper device according to the first exemplary embodiment during operation.

FIG. 8 is a plan view of a vehicle wiper device according to the first exemplary embodiment during operation.

FIG. 9 is a circuit diagram schematically illustrating circuits of a wiper system according to the first exemplary embodiment.

FIG. 10A is a diagram illustrating an example of second output shaft rotation angle maps that define rotation angles of a second output shaft according to rotation angles of a first output shaft in the first exemplary embodiment.

FIG. 10B illustrates an example of variation over time of a rotation angle of a second output shaft 12A in the first exemplary embodiment.

FIG. 10C illustrates an example of variation over time in angular velocity of a second output shaft 12A in the first exemplary embodiment.

FIG. 11 is a schematic diagram illustrating an example of wiping ranges by a wiper system according to the first exemplary embodiment.

FIG. 12 is a flowchart illustrating an example of wiping change processing in a wiper system according to the first exemplary embodiment.

FIG. 13 is a flowchart illustrating another example of wiping change processing in a wiper system according to the first exemplary embodiment.

FIG. 14 is a schematic diagram illustrating second output shaft rotation angle maps of a modified example of the first exemplary embodiment.

FIG. 15 is an explanatory diagram illustrating wiping ranges in cases in winch second output shaft rotation angle maps illustrated in FIG. 14 are employed.

FIG. 16 is a schematic diagram illustrating an example of a vehicle wiper device in which a wiping range by a front passenger seat side wiper blade is changed by transmitting drive force front a motor to a front passenger seal side wiper arm through a four-bar linkage mechanism.

FIG. 17 is a schematic diagram illustrating an example of a vehicle wiper system including a vehicle wiper device according to a second exemplary embodiment of the present disclosure.

FIG. 18 is a schematic diagram illustrating an example of a front passenger seat side wiper blade according to the second exemplary embodiment.

FIG. 19A is a schematic diagram illustrating a side face of a front passenger seal side wiper blade according to the second exemplary embodiment.

FIG. 19B is an enlarged diagram of a base end portion of a front passenger seal side wiper blade according to the second exemplary embodiment.

FIG. 20 is an explanatory diagram illustrating a fixing method of a blade rubber of a front passenger seat side wiper blade according to the second exemplary embodiment.

FIG. 21 is an explanatory diagram illustrating a fixing method of a blade rubber of a front passenger seat side wiper blade according to the second exemplary embodiment.

FIG. 22 illustrates an example of a second output shaft rotation angle maps defining rotation angles of a second output shaft according to rotation angles of a first output shaft in the second exemplary embodiment.

FIG. 23 is a schematic diagram illustrating an example of wiping ranges corresponding to the second output shaft rotation angle maps illustrated in FIG. 22.

FIG. 24 is a flowchart illustrating an example of wiping change processing of a wiper system according to the second exemplary embodiment.

FIG. 25 is a flowchart illustrating a simplified example of wiping change processing of a wiper system according to the second exemplary embodiment.

FIG. 26 is a schematic diagram illustrating an example of a vehicle wiper device in which a wiping range cannot be changed.

### DESCRIPTION OF EMBODIMENTS

### First Exemplary Embodiment

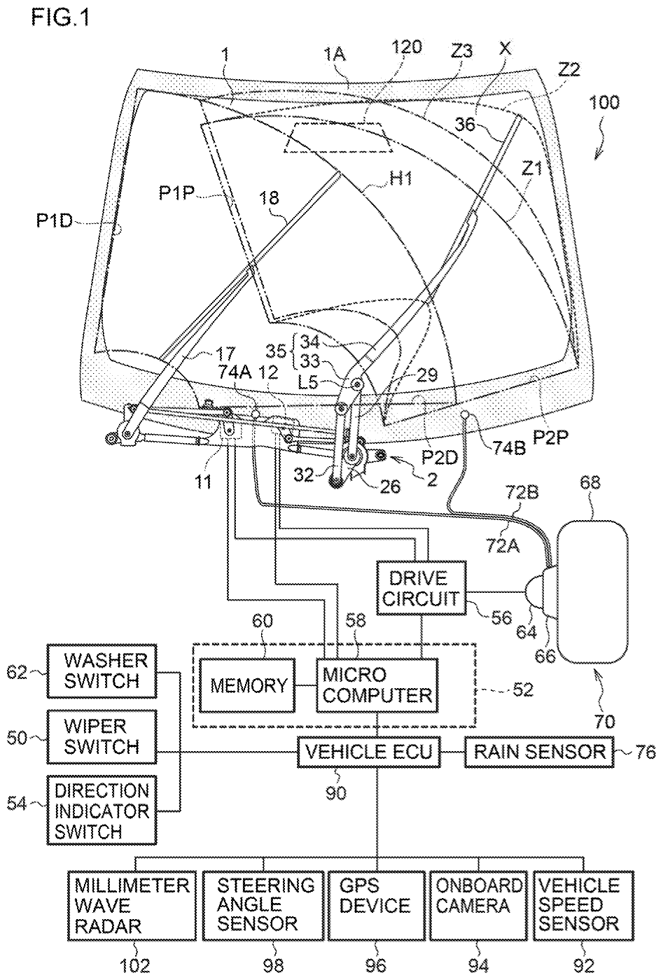

FIG. 1 is a schematic diagram illustrating an example of a wiper system 100 including a vehicle wiper device (referred to hereafter as “wiper device”) 2 according to a first exemplary embodiment of the present disclosure. The wiper system 100 illustrated in FIG. 1 is used to wipe a windshield glass 1 installed as a windshield in a vehicle such as a passenger car, and the wiper system 100 includes a pair of wiper arms (a driver's seat side wiper arm 17 and a front passenger seat side wiper arm 35, described later), a first motor 11, a second motor 12, a control circuit 52, a drive circuit 56, and a washer device 70.

FIG. 1 illustrates a case of a right hand drive vehicle, and therefore the right side of the vehicle (the left side in FIG. 1) configures a driver's seat side, and the left side of the vehicle (the right side in FIG. 1) configures a front passenger seal side. In the case of a left hand drive vehicle, the left side of the vehicle (the right side in FIG. 1) would configure the driver's seat side, and the right side of the vehicle (the left side in FIG. 1) would configure the front passenger seat side. The configuration of the wiper device 2 would be reversed from left to right were the vehicle a left hand drive vehicle.

An output shaft of the first motor 11 is rotated forward and rotated in reverse within a predetermined rotation angle range, and thereby configures a drive source to operate the driver's seat side wiper arm 17 and the front passenger seat side wiper arm 35 to-and-fro across the windshield glass 1. In the first exemplary embodiment, when the first motor 11 is rotated forward, a driver's seat side wiper blade 18 of the driver's seat side wiper arm 17 is operated so as to wipe from a lower return position P2D to an upper return position P1D, and a front passenger seat side wiper blade 36 of the front passenger seat side wiper arm 35 is operated so as to wipe from a lower return position P2P to an upper return position P1P. When the first motor 11 is rotated in reverse, the driver's seat side wiper blade 18 of the driver's seat side wiper arm 17 is operated so as to wipe from the upper return position P1D to the lower return position P2D, and the from passenger seat side wiper blade 36 of the front passenger seat side wiper arm 35 is operated so as to wipe from the upper return position P1P to the lower return position P2P.

An outer edge portion of the windshield glass 1 is configured by a light-blocking portion 1A that is coated with a black ceramic pigment in order to block visible light and ultraviolet rays. The black pigment is coated onto the outer edge portion on a vehicle cabin inside of the windshield glass 1, and then heated to a predetermined temperature such dial the black pigment melts and adheres to the vehicle cabin side face of the windshield glass 1. The windshield glass 1 is fixed to a vehicle body using an adhesive coated on the outer edge portion, and providing the outer edge portion with the light-blocking portion 1A that does not allow ultraviolet rays to pass through as illustrated in FIG. 1 suppresses ultraviolet degradation of the adhesive.

When the second motor 12, described later, is not operational, the output shaft of the first motor 11 (a first output shaft 11A, described later) is rotated forward and rotated in reverse by a rotation angle from 0° to a predetermined rotation angle (referred to hereafter as the “first predetermined rotation angle”), such that the driver's seat side wiper blade 18 wipes a wiping range H1, and the from passenger seat side wiper blade 36 wipes a wiping range Z1.

The second motor 12 is a drive source for causing the front passenger seat side wiper arm 35 to appear to extend. An output shaft (a second output shaft 12A, described later) of the second motor 12 is rotated forward and rotated in reverse by a rotation angle from 0° to a predetermined rotation angle (referred to hereafter as the “second predetermined rotation angle”). Operating the second motor 12 while the first motor 11 described above is operational causes the front passenger seat side wiper arm 35 to appear to extend upward on the front passenger seat side such that the front passenger seat side wiper blade 36 wipes a wiping range Z2. Moreover, changing the magnitude of the second predetermined rotation angle enables the extension range of the front passenger seat side wiper arm 35 to be changed. For example, increasing the second predetermined rotation angle enlarges the extension range of the front passenger seal side wiper arm 35, and decreasing the second predetermined rotation angle reduces the extension range of the front passenger seat side wiper arm 35. As described later, in the first exemplary embodiment, in addition to the wiping ranges Z1, Z2, a wiping range Z3 may also be wiped according to circumstances.

The first motor 11 and the second motor 12 are motors capable of being controlled such that the rotation directions of the respective output shafts corresponds to forward rotation or reverse rotation, and that also allow the rotation speeds of their respective output shafts to be controlled. For example, the first motor 11 and the second motor 12 are configured by either brushed DC motors or brush less DC motors.

The control circuit 52 is connected to the first motor 11 and the second motor 12 in order to control rotation thereof. For example, the control circuit 52 according to the first exemplary embodiment computes respective voltage duty ratios to be applied to the first motor 11 and the second motor 12 based on the rotation directions, rotation positions, rotation speeds, and rotation angles of the output shafts of the first motor 11 and the second motor 12, detected by absolute angle sensors (not illustrated in the drawings), serving as “rotation angle detection sections”, provided in the vicinity of ends of the output shafts of the first motor 11 and the second motor 12.

In the first exemplary embodiment, the voltages to be applied to the first motor 11 and the second motor 12 are generated by Pulse Width Modulation (PWM) in which a voltage (approximately 12V) of an onboard battery, configuring a power source, is switched ON and OFF using switching elements to modulate a pulse-shaped waveform. The duty ratios in the first exemplary embodiment refer to the proportion of the duration of one pulse generated by switching ON the aforementioned switching elements with respect to a single cycle of the voltage waveform generated by PWM. The single cycle of the voltage waveform generated by PWM is the sum of the duration of a single pulse and the duration for which the aforementioned switching elements are OFF and a pulse is not generated. The drive circuit 56 switches switching elements within the drive circuit 56 ON and OFF according to the duty ratios computed by the control circuit 52 to generate the respective voltages to be applied to the first motor 11 and the second motor 12, and the generated voltages are applied to respective coil terminals of the first motor 11 and the second motor 12.

The first motor 11 and the second motor 12 according to the first exemplary embodiment each include a speed reduction mechanism configured by a worm gear, such that the rotation directions, rotation speeds, and rotation angles of the respective output shafts are not the same as the respective rotation speeds and rotation angles of the first motor 11 and the second motor 12. However, in the first exemplary embodiment, the respective motors and the respective speed reduction mechanisms are integral and indivisible, and therefore the rotation speeds and rotation angles of the respective output shafts of the first motor 11 and the second motor 12 are hereafter considered to be the respective rotation directions, rotation speeds, and rotation angles of the first motor 11 and the second motor 12.

The absolute angle sensors are, for example, provided within the respective speed reduction mechanisms of the first motor 11 and the second motor 12, and are configured by sensors that detect by converting into current the magnetic fields (magnetism) of excitation coils or magnets that rotate in coordination with the respective output shafts. The absolute angle sensors are, for example, configured by magnetic sensors such as MR sensors.

The control circuit 52 includes a microcomputer 58 that is capable of computing the position of the driver's seat side wiper blade 18 on the windshield glass 1 from the rotation angle of the output shaft of the first motor 11 detected by the absolute angle sensor provided in the vicinity of the end of the output shaft of the first motor. The microcomputer 58 controls the drive circuit 56 so as to vary the rotation speed of the output shaft of live first motor 11 according to the computed position.

The microcomputer 58 also computes the position of the front passenger seat side wiper blade 36 on the windshield glass 1 from the rotation angle of the output shaft of the first motor 11 detected by the absolute angle sensor provided in the vicinity of the end of the output shaft of the first motor, and controls the drive circuit 56 so as to vary the rotation speed of the output shaft of the second motor 12 according to the computed position. The microcomputer 58 also computes the degree of extension of the front passenger seat side wiper arm 35 from the rotation angle of the output shaft of the second motor 12 detected by the absolute angle sensor provided in the vicinity of the end of the output shaft of the second motor 12.

The control circuit 52 is provided with memory 60 configured by a storage device stored with data and a program employed in control of the drive circuit 56. The memory 60 is stored with data and a program for computing the rotation speeds and the like (including the rotation angles) of the respective output shafts of the first motor 11 and the second motor 12 according to the rotation angle of the output shaft of the first motor 11 that represents the positions of the driver's seat side wiper blade 18 and the front passenger seat side wiper blade 36 on the windshield glass 1.

A vehicle Electronic Control Unit (ECU) 90 that consolidates control of the vehicle engine and the like is also connected to the microcomputer 58. A wiper switch 50, a direction indicator switch 54, a washer switch 62, a rain sensor 76, a vehicle speed sensor 92 that detects the speed of the vehicle, an onboard camera 94 that images ahead of the vehicle, a Global Positioning System (GPS) device 96, a steering angle sensor 98, and millimeter wave radar 102 are connected to the vehicle ECU 90.

The wiper switch 50 is a switch to switch power supplied to the first motor 11 from the vehicle battery ON and OFF. The wiper switch 50 is capable of switching operation of the driver's seat side wiper blade 18 and the front passenger seat side wiper blade 36 between a low speed operation mode selection position for low speed operation, a high speed operation mode selection position for high speed operation, an intermittent operation mode selection position for intermittent operation at a specific interval, an AUTO operation mode selection position to operate when raindrops have been detected by the rain sensor 76, and a stow (stationary) mode selection position. Signals corresponding to the respective mode selection positions are output to the microcomputer 58 through the vehicle ECU 90. Note that when the wiper switch 50 is at the intermittent operation mode selection position, the driver's seat side wiper blade 18 and the front passenger seat side wiper blade 36 are operated at low speed.

When a signal output from the wiper switch 50 according to the mode selection position is input to the microcomputer 58 through the vehicle ECU 90, the microcomputer 58 employs the data and the program stored in the memory 60 to perform control corresponding to the output signal from the wiper switch 50.

In the first exemplary embodiment, the wiper switch 50 may be provided with a separate change mode switch to change the wiping range of the front passenger seal side wiper blade 36 to the wiping range Z2. When such a change mode switch is switched ON, a predetermined signal is input to the microcomputer 58 through the vehicle ECU 90. When the predetermined signal is input to the microcomputer 58. for example, the second motor 12 is controlled so the wiping range Z2 is wiped when the from passenger seat side wiper blade 36 is operating from the lower return position P2P toward the upper return position P1P.

The direction indicator switch 54 is a switch used to instruct operation of a vehicle direction indicator (not illustrated in the drawings). The direction indicator switch 54 is operated by the driver to output a signal to switch ON a left or right direction indicator to the vehicle ECU 90. The vehicle ECU 90 flashes a left or right direction indicator lamp based on the signal output from the direction indicator switch 54. The signal output from the direction indicator switch 54 is also input to the microcomputer 58 through the vehicle ECU 90.

The washer switch 62 is a switch used to switch ON or OFF power supplied from the vehicle battery to a washer motor 64, the first motor 11, and the second motor 12. For example, the washer switch 62 is integrally provided to an operation means such as a lever provided with the wiper switch 50 described above, and is switched ON by an operation to pull the lever or the like toward the occupant When the washer switch 62 is ON. the microcomputer 58 actuates the washer motor 64 and the first motor 11. The microcomputer 58 controls the second motor 12 so as to wipe the wiping range Z2 when the front passenger seal side wiper blade 36 is wiping from the lower return position P2P toward the upper return position P1P, and so as to wipe the wiping range Z1 when the front passenger seat side wiper blade 36 is wiping from the upper return position P1P toward the lower return position P2P. This control enables the windshield glass 1 to be wiped over a wider range on the front passenger seat side.

While the washer switch 62 is ON, a washer pump 66 is driven by rotation of the washer motor 64 provided to the washer device 70. The washer pump 66 conveys washer fluid under pressure from a washer fluid tank 68 to a driver's seal side hose 72A and a front passenger seat side hose 72B. The driver's seal side hose 72A is connected to a drivers seat side nozzle 74A provided below the driver's seat side of the windshield glass 1. The front passenger seat side hose 72B is connected to a front passenger seal side nozzle 74B provided below the front passenger seat side of the windshield glass 1. The washer fluid that has been conveyed under pressure is jetted onto the windshield glass 1 through the driver's seat side nozzle 74A and the front passenger seat side nozzle 74B. Washer fluid that has adhered to the windshield glass 1 is wiped away together with dirt on the windshield glass 1 by operation of the driver's seat side wiper blade 18 and the front passenger seat side wiper blade 36.

The microcomputer 58 controls live washer motor 64 such that the washer motor 64 only operates while the washer switch 62 is ON. The microcomputer 58 also controls the first motor 11 such that the driver's seat side wiper blade 18 and the front passenger seat side wiper blade 36 continue to operate until they reach the lower return positions P2D, P2P even when the washer switch 62 has been switched OFF. The microcomputer 58 also controls the second motor 12 such that the wiping range Z2 is wiped until the driver's seat side wiper blade 18 and the front passenger seat side wiper blade 36 reach the upper return positions P1D. P1P as a result of the rotation of the first motor 11, even if the washer switch 62 has been switched OFF while the driver's seat side wiper blade 18 and the front passenger seat side wiper blade 36 are wiping toward the upper return positions P1D, P1P.

The rain sensor 76 is, for example, a type of optical sensor provided at the vehicle cabin inside of the windshield glass 1, and detects raindrops on a front face of the windshield glass 1. As an example, the rain sensor 76 includes an LED configuring an infrared light-emitting element, a photodiode configuring a light receptor element, a lens to form an optical path for the infrared light, and a control circuit. Infrared light emitted from the LED is totally reflected by the windshield glass 1; however, if raindrops are present on the front face of the windshield glass 1, some of the infrared light passes through the raindrops and escapes to the exterior, thus reducing the amount of reflection by the windshield glass 1. As a result, the amount of light entering the photodiode configuring the light receptor element decreases. Raindrops on the front face of the windshield glass 1 are detected based on this reduction in the amount of light.

The vehicle speed sensor 92 is a sensor that detects a revolution speed of a vehicle wheel and outputs a signal representing the revolution speed. The vehicle ECU 90 computes a vehicle speed from the signal output by the vehicle speed sensor 92 and the circumferential length of the wheel.

The onboard camera 94 is a device that acquires video image data by imaging ahead of the vehicle. The vehicle ECU 90 performs image processing on the video image data acquired by the onboard camera 94 to enable determination such as whether or not the vehicle is coming into a curve. The vehicle ECU 90 is also capable of computing the brightness ahead of the vehicle from the luminance of the video image data acquired by the onboard camera 94.

Note that the rain sensor 76 and the onboard camera 94 are, for example, provided at positions corresponding to a central upper portion on the vehicle cabin inside of the windshield glass 1. More specifically, the rain sensor 76 and the onboard camera 94 are provided in a functional area 120 corresponding to the reverse side of a rear-view mirror or the like.

When the wiper switch 50 is at the AUTO operation mode selection position, the microcomputer 58 may control the second motor 12 so as to wipe the wiping range Z2 or the wiping range Z3 when the rain sensor 76 has detected raindrops on the front face of the windshield glass 1, for example in the functional area 120.

Moreover, when the wiper switch 50 is at the AUTO operation mode selection position, the microcomputer 58 may control the second motor 12 so as to wipe the wiping range Z2 or the wiping range Z3 based on pixel feature amounts in the image data acquired by the onboard camera 94. For example, the microcomputer 58 controls the second motor 12 so as to wipe the wiping range Z2 or the wiping range Z3 in cases in which a difference between image feature amounts corresponding to the wiping range Z1 of the windshield glass 1 and image feature amounts corresponding to a non-wiped range X of the windshield glass 1 in tire image data acquired by the onboard camera 94 is a predetermined value or greater.

Luminance values are one example of image feature amounts. The microcomputer 58 determines adhered material to be present in the non-wiped range X and controls the second motor 12 so as to wipe the wiping range Z2 or the wiping range Z3 in cases in which a difference between a luminance value for the wiping range Z1 and a luminance value for the non-wiped range X is a predetermined value or greater.

The image feature amounts also include an optical flow representing a movement vector of a leading end portion of the front passenger seat side wiper blade 36. In cases in which a change amount of the movement vector of the leading end portion of the front passenger seat side wiper blade 36 represented by the optical flow is a predetermined value or lower, the microcomputer 58 assumes that accumulated snow is present on the windshield glass 1, and controls the second motor 12 so as to wipe the wiping range Z2 or the wiping range Z3.

In the first exemplary embodiment, the wiping range Z2 is wiped in cases in which the wiper switch 50 is at the low speed operation mode selection position for low speed operation of the driver's seat side wiper blade 18 and the from passenger seat side wiper blade 36, and the wiping range Z3 is wiped in cases in which the wiper switch 50 is at the high speed operation mode selection position for high speed operation of the driver's seat side wiper blade 18 and the front passenger seat side wiper blade 36. Extension of the front passenger seat side wiper arm 35 is performed rapidly in a high speed wiping operation, and so there is a concern that the load on a link mechanism to extend the front passenger seat side wiper arm 35 and on the second motor 12 could become large, and that rushed extension of the front passenger seat side wiper arm 35 could distract a user. In the first exemplary embodiment, when wiping at high speed, the front passenger seal side wiper arm 35 is extended to a degree enabling wiping of the functional area 120, and the wiping range Z3 is wiped. Accordingly, as illustrated in FIG. 1, the wiping range Z3 is set so as to enable the entirety of the functional area 120 to be covered.

The GPS device is a device that computes a current position of the vehicle based on positioning signals received from a GPS satellite above. Although the wiper system 100 employs the dedicated GPS device 96 in the first exemplary embodiment, in cases in which the vehicle is provided with another GPS device such as a car navigation system, this other GPS device may be employed.

The steering angle sensor 98 is, for example, a sensor that is provided to a steering rotation shaft (not illustrated in the drawings) of a steering wheel to detect a rotation angle of the steering wheel.

The millimeter wave radar 102 includes forward millimeter wave radar that detects the distance to obstacles ahead, from-and-side millimeter wave radar that detects the distance to obstacles to the front-and-side, rearward millimeter wave radar that detects the distance to obstacles to the rear, and rear-and-side millimeter wave radar that detects the distance to obstacles to the rear-and-side.

The forward millimeter wave radar is, for example, provided in the vicinity of the center of a front grille of the vehicle. The front-and-side millimeter wave radar is provided in the vicinity of both vehicle width direction ends inside a bumper. The forward millimeter wave radar and the front-and-side millimeter wave radar respectively emit millimeter waves ahead and toward the front-and-side of the vehicle and receive electromagnetic waves reflected from a target object, and measure the distance to the target object, the speed of the target object relative to the vehicle, and the like based on the propagation time, frequency differences arising due to the Doppler effect, and so on. The rearward millimeter wave radar and the rear-and-side millimeter wave radar are provided to a rear bumper or the like of the vehicle, and respectively emit millimeter waves rearward and toward the rear-and-side of the vehicle and receive electromagnetic waves reflected from a target object, and measure the distance to the target object, the speed of the target object relative to the vehicle, and the like based on the propagation time, frequency differences arising due to the Doppler effect, and so on.

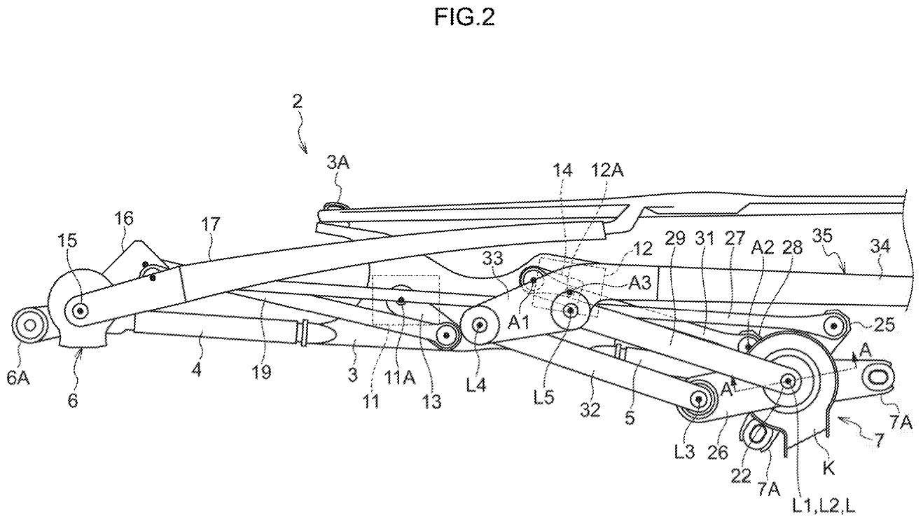

Explanation follows regarding configuration of the wiper device 2 according to the first exemplary embodiment, with reference to FIG. 2 to FIG. 8. As illustrated in FIG. 2 and FIG. 4 to FIG. 8, the wiper device 2 according to the first exemplary embodiment includes a plate shaped central frame 3 and a pair of pipe frames 4, 5 that each have one end portion fixed to the the central frame 3 and that extend toward both vehicle width direction sides from the central frame 3. A first holder member 6 including a driver's seat side pivot shaft 15 of the driver's seat side wiper arm 17 and the like is formed at another end portion of the pipe frame 4. A second holder member 7 provided with a second from passenger seat side pivot shaft 22 of the front passenger seat side wiper arm 35 and the like is formed at another end portion of the pipe frame 5. The wiper device 2 is supported by the vehicle at a support portion 3A provided to the central frame 3, and a fixing portion 6A of the first holder member 6 and a fixing portion 7A of the second holder member 7 are respectively fixed to the vehicle by fastening to the vehicle body using bolts or the like.

The first motor 11 and the second motor 12 to drive the wiper device 2 are provided to the wiper device 2 at a reverse face (a face facing toward the vehicle cabin inside) of the central frame 3. The first output shaft 11A of the first motor 11 passes through the central frame 3 and projects out at a front face (a face on the vehicle exterior side) of the central frame 3. One end of a first drive crank arm 13 is fixed to a leading end portion of the first output shaft 11A. The second output shaft 12A of the second motor 12 passes through the central frame 3 and projects out at the front face of the central frame 3. One end of a second drive crank arm 14 is fixed to a leading end portion of the second output shaft 12A.

The driver's seat side pivot shaft 15 is rotatably supported by the first holder member 6, and one end of a driver's seat side swing lever 16 is fixed to a base end portion (the far side in FIG. 2) of the driver's seat side pivot shaft 15. An arm head of the driver's seat side wiper arm 17 is fixed to a leading end portion (the near side in FIG. 2) of the driver's seat side pivot shaft 15. As illustrated in FIG. 1, the driver's seat side wiper blade 18 for wiping the driver's seat side of the windshield glass 1 is coupled to the leading end portion of the driver's seat side wiper arm 17.

Another end of the first drive crank arm 13 and another end of the driver's seat side swing lever 16 are coupled together through a first coupling rod 19. When the first motor 11 is driven, the first drive crank arm 13 rotates, and rotation force of the first drive crank arm 13 is transmitted to the driver's seat side swing lever 16 through the first coupling rod 19 to swing the driver's seat side swing lever 16. The swinging of the driver's seat side swing lever 16 swings the driver's seat side wiper arm 17, such that the driver's seal side wiper blade 18 wipes the wiping range H1 between the lower return position P2D and the upper return position P1D.

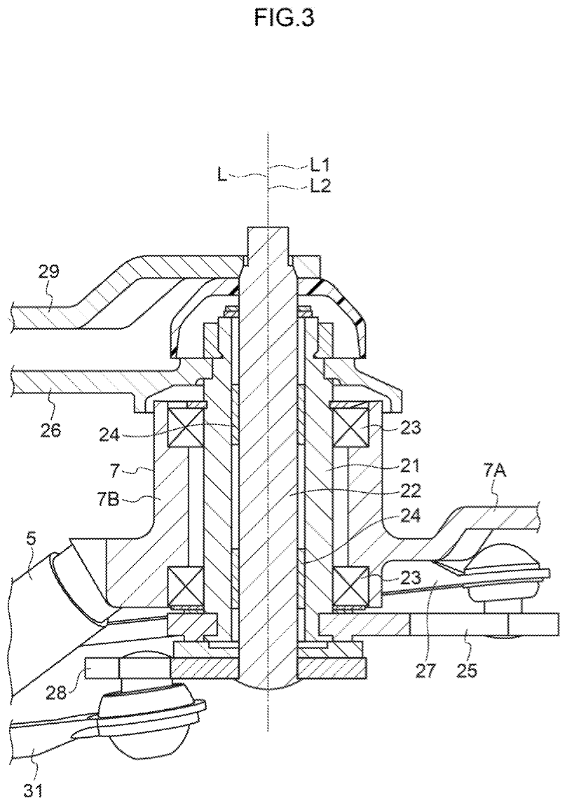

FIG. 3 is a cross-section illustrating the second holder member 7, sectioned along line A-A in FIG. 2. As illustrated in FIG. 3, the second holder member 7 supports a first from passenger seat side pivot shaft 21 so as to be capable of rotating about a first axis L1, and supports the second front passenger seat side pivot shaft 22 so as to be capable of rotating about a second axis L2. In the first exemplary embodiment, live first axis L1 and the second axis L2 are disposed on the same straight line L (are concentric). Note that FIG. 3 illustrates a state in which a waterproof cover K, illustrated in FIG. 2 and FIG. 4 to FIG. 8, has been removed.

The second holder member 7 is formed with a lube shaped portion 7B. The first front passenger seat side pivot shaft 21 is rotatably supported at an inner peripheral side of the portion 7B through a shaft bearing 23. The first front passenger seat side pivot shaft 21 is formed to a tube shape, and the second front passenger seat side pivot shaft 22 is rotatably supported at the inner peripheral side of the first front passenger seat side pivot shaft 21 through a shaft bearing 24.

One end of a first front passenger seat side swing lever 25 is fixed to a base end portion of the first front passenger seal side pivot shaft 21, and one end of a first drive lever 26 is fixed to a leading end portion of the first front passenger seat side pivot shaft 21. As illustrated in FIG. 2, another end of the first front passenger seat side swing lever 25 and another end of the driver's seat side swing lever 16 are coupled together by a second coupling rod 27. Accordingly, when the first motor 11 is driven so as to swing the driver's seat side swing lever 16, the second coupling rod 27 transmits drive force to the first front passenger seat side swing lever 25, thereby swinging (rotating) the first drive lever 26 about the first axis L1 together with the first front passenger seal side swing lever 25.

As illustrated in FIG. 3, the second front passenger seat side pivot shaft 22 is formed longer than the first front passenger seat side pivot shaft 21, and a base end portion and a leading end portion of the second front passenger seal side pivot shaft 22 project from the first front passenger seat side pivot shaft 21 in the axial direction. One end of a second front passenger seat side swing lever 28 is fixed to the base end portion of the second front passenger seat side pivot shaft, and one end of a second drive lever 29 is fixed to the leading end portion of the second front passenger seat side pivot shaft 22.

Another end of the second drive crank arm 14 and another end of the second front passenger seat side swing lever 28 are coupled together by a third coupling rod 31. Accordingly, when the second motor 12 is driven, the second drive crank arm 14 rotates and the third coupling rod 31 transmits drive force of the second drive crank arm 14 to the second front passenger seat side swing lever 28, thereby swinging (rotating) the second drive lever 29 together with the second front passenger seat side swing lever 28. Although the first front passenger seat side pivot shaft 21 and the second front passenger seat side pivot shaft 22 are provided coaxially to each other as described above, the first front passenger seat side pivot shaft 21 and the second front passenger seat side pivot shaft 22 do not move in coordination with each other, and the first front passenger seal side pivot shaft 21 and the second from passenger seat side pivot shaft 22 rotate independently of each other.

As illustrated in FIG. 2 and FIG. 4 to FIG. 8, the wiper device 2 includes a first following lever 32. A base end portion of the first following lever 32 is coupled to another end side of the first drive lever 26 so as to be capable of rotating about a third axis L3.

The wiper device 2 includes an arm head 33 configuring a second following lever. A base end portion of the arm head 33 is coupled to a leading end side of the first following lever 32 so as to be capable of rotating about a fourth axis L4, and a leading end side of the arm head 33 is coupled to another end side of the second drive lever 29 so as to be capable of rotating about a fifth axis L5. The arm head 33 configures the from passenger seat side wiper arm 35 together with a retainer 34, of which a base end portion is fixed to a leading end of the arm head 33. The front passenger seat side wiper blade 36 is coupled to a leading end portion of the front passenger seat side wiper arm 35 so as to wipe the front passenger seat side of the windshield glass 1.

The first drive lever 26, the second drive lever 29, the first following lever 32, and the arm head 33 are coupled to one another such that a length from the first axis L1 (second axis L2) to the third axis L3 and a length from the fourth axis L4 to the fifth axis L5 are the same as each other. The first drive lever 26, the second drive lever 29. the first following lever 32, and the arm head 33 are also coupled together such that a length from the third axis L3 to the fourth axis L4 and a length from the first axis L1 (second axis L2) to the fifth axis L5 are the same as each other. Accordingly, the first drive lever 26 and the arm head 33 are retained parallel to each other, and the second drive lever 29 and the first following lever 32 are retained parallel to each other, and the first drive lever 26. the second drive lever 29, the first following lever 32, and the arm head 33 configure a substantially parallelogram shaped link mechanism (extension and retraction mechanism).

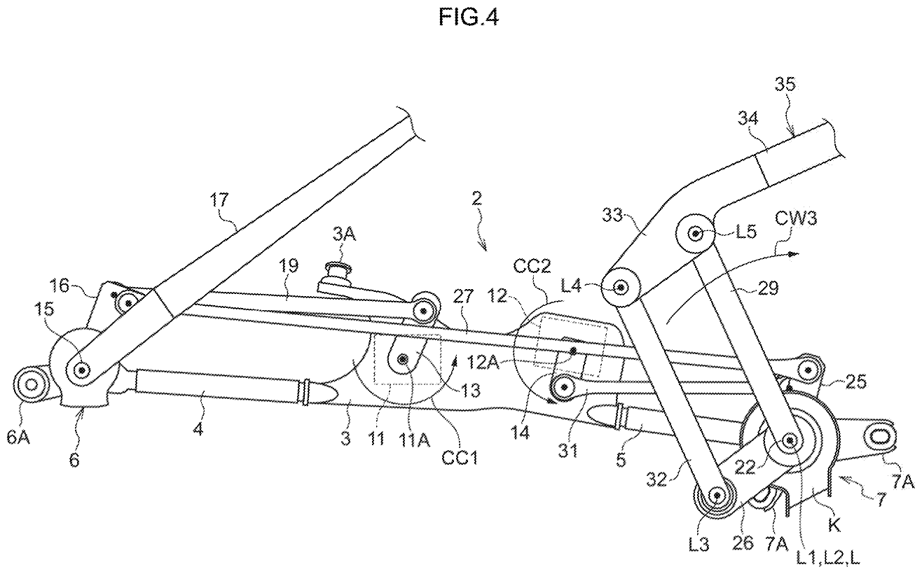

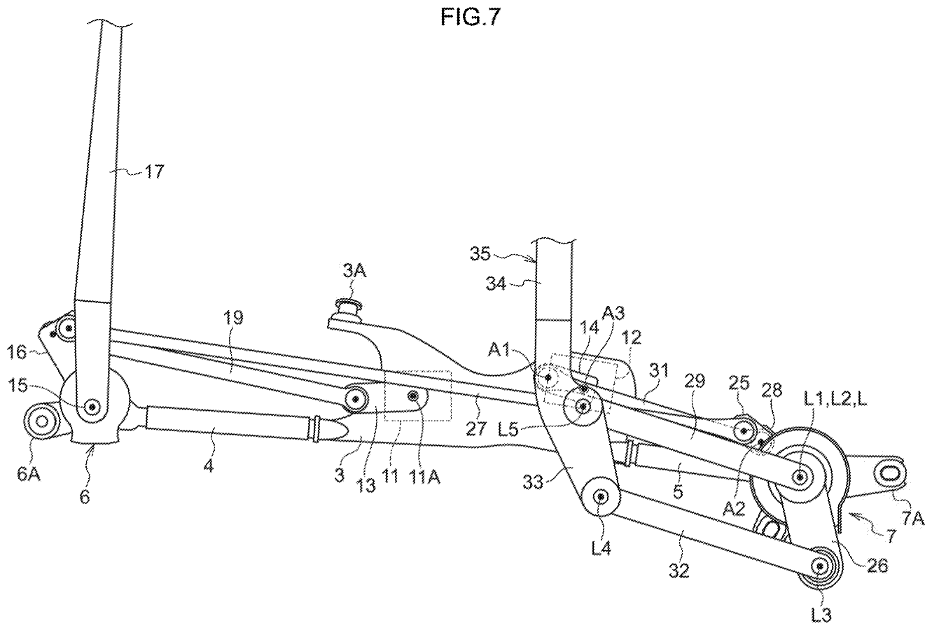

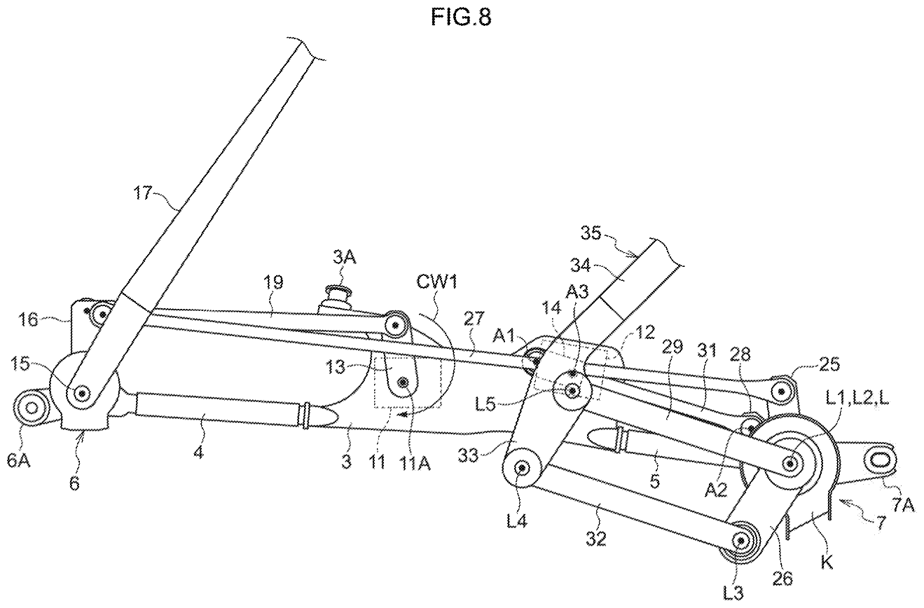

The fifth axis L5 is a pivot point during operation of the front passenger seal side wiper arm 35. The front passenger seat side wiper arm 35 is rotated about the fifth axis L5 by drive force of the first motor 11 so as to travel to-and-fro across the windshield glass 1. Moreover, as illustrated in FIG. 4 to FIG. 6, the second motor 12 moves the fifth axis L5 toward the lop of the windshield glass 1 compared to the positions illustrated in FIG. 2, FIG. 7, and FIG. 8 through the substantially parallelogram shaped link mechanism configured by the first drive lever 26, the second drive lever 29, the first following lever 32, and the arm head 33. This movement of the fifth axis L5 makes the front passenger seat side wiper arm 35 appear to extend. Accordingly, the from passenger seat side wiper blade 36 wipes the wiping range Z2 when the first motor 11 and the second motor 12 are operated together.

When the first motor 11 is operated alone without operating the second motor 12, the fifth axis L5 does not move from the position illustrated in FIG. 2, FIG. 7, and FIG. 8 (referred to hereafter as a “first position”). Accordingly, the front passenger seat side wiper arm 35 operates between the lower return position P2P and the upper return position P1P so as to describe a substantially circular are shaped trajectory centered on the fifth axis L5 at an unvarying position, such that the front passenger seal side wiper blade 36 wipes the substantially fan-shaped wiping range Z1.

In the first exemplary embodiment, when there is a need to wipe the windshield glass 1 over a wider range, on an outward journey (on an outward wiping path) of the front passenger seat side wiper blade 30 from the lower return position P2P toward the upper return position P1P, the first motor 11 and the second motor 12 are respectively controlled so as to wipe the wiping range Z2 or the wiping range Z3. Then, on a return journey (on a return wiping path) of the front passenger seat side wiper blade 36 from the upper return position P1P to live lower return position P2P after having reversed in direction at the upper return position P1P, the first motor 11 and the second motor 12 are respectively controlled so as to wipe the wiping range Z1. As the front passenger seat side wiper blade 36 moves to-and-fro between the lower return position P2P and the upper return position P1P. the wiping range Z2 or the wiping range Z3 is wiped on the outward journey, and the wiping range Z1 is wiped on the return journey. This enables the windshield glass 1 to be wiped over a wide range. Alternatively, the windshield glass 1 may be wiped over a wide range by wiping the wiping range Z1 on the outward journey and wiping the wiping range Z2 or the wiping range Z3 on the return journey as the front passenger seat side wiper blade 36 travels to-and-fro between the lower return position P2P and the upper return position P1P. Alternatively, configuration may be made in which the wiping range Z2 or the wiping range Z3 is wiped on the outward journey and on the return journey.

Explanation follows regarding operation of the wiper device 2 according to the first exemplary embodiment. In the first exemplary embodiment, the driver's seat side wiper arm 17 and the driver's seat side wiper blade 18 only operate centered on the driver's seat side pivot shaft 15 accompanying rotation of the first motor 11. Accordingly, the following detailed explanation focuses on the operation of the front passenger seat side wiper arm 35 and the front passenger seat side wiper blade 36.

FIG. 2 illustrates a state in which the front passenger seat side wiper blade 36 is positioned at the lower return position P2P, and the front passenger seat side wiper arm 35 is at a stationary position. When either the washer switch 62 or the change mode switch previously described is switched ON when in this state, the first output shaft 11A of the first motor 11 rotates in the rotation direction CC1 illustrated in FIG. 4 under the control of the control circuit 52, thus starting rotation of the first drive lever 26 and starting a rotation operation of the front passenger seat side wiper arm 35 centered on the fifth axis L5. At the same time, the second output shaft 12A of the second motor 12 also starts rotating in the rotation direction CC2 illustrated in FIG. 4. Note that in the first exemplary embodiment, rotation of the first output shaft 11A in the rotation direction CC1 and rotation of the second output shaft 12A in the rotation direction CC2 both correspond to forward rotation of the respective output shafts.

FIG. 4 illustrates a state in which the front passenger seat side wiper blade 36 has wiped partway across the windshield glass 1 (approximately one quarter of an outward stroke). In the first exemplary embodiment, when the first motor 11 starts rotating in the rotation direction CC1, drive force due to the rotation of the second motor 12 in the rotation direction CC2 is transmitted to the second drive lever 29. When this drive force of the second motor 12 is transmitted to the second drive lever 29, the second drive lever 29 operates in an operation direction CW3, and moves the fifth axis L5 configuring the pivot point of the front passenger seat side wiper arm 35 toward the top of the front passenger seat side of the windshield glass 1.

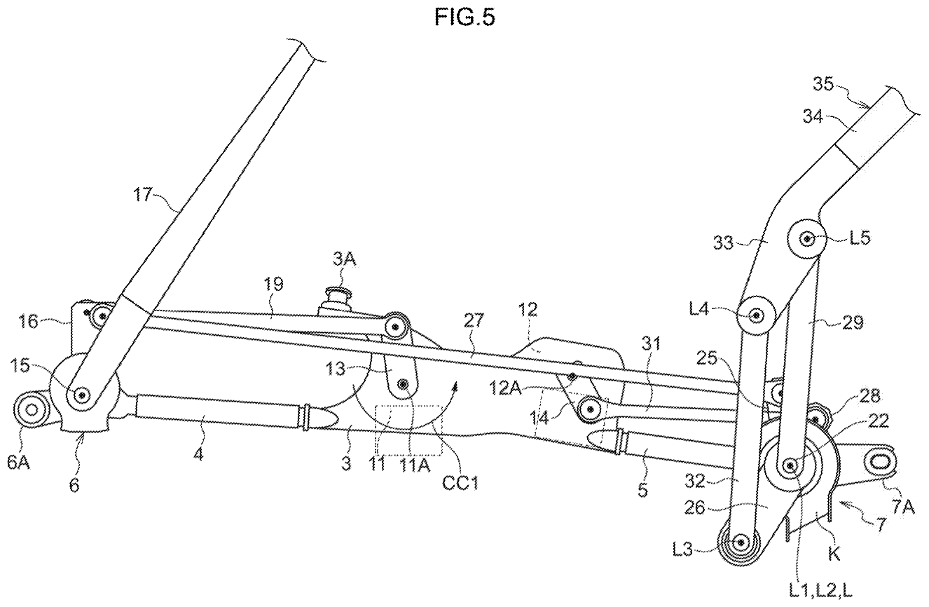

FIG. 5 illustrates a case in which the first output shaft 11A has rotated to an intermediate rotation angle between 0° and the first predetermined rotation angle, such that the first drive lever 26 been rotated and the front passenger seat side wiper blade 36 has reached a substantially intermediate point on the stroke (outward stroke) between the lower return position P2P and the upper return position P1P. In FIG. 5, the second output shaft 12A of the second motor 12 is also in a state having been rotated by the second predetermined rotation angle in the rotation direction CC2 illustrated in FIG. 4. The second output shaft 12A has reached a maximum rotation angle of forward rotation, such that the fifth axis L5 configuring the pivot point of the front passenger seat side wiper arm 35 has been lifted to an uppermost position (second position) by the second drive crank arm 14, the third coupling rod 31, the second from passenger seat side swing lever 28, and the second drive lever 29. As a result, as illustrated in FIG. 1, a leading end portion of the front passenger seal side wiper blade 36 is moved to a position close to the upper corner of the front passenger seat side of the windshield glass 1. Note that the intermediate rotation angle described above is approximately half of the first predetermined rotation angle; however, this may be set on a case-by-case basis according to the shape of the windshield glass 1 and the like. Note that the second position is the uppermost position at which the fifth axis L5 is disposed at each change ratio. To describe this in more detail, the second position is a position at which the fifth axis L5 is disposed when the first output shaft 11A has rotated to the intermediate rotation angle between 0° C. and the first predetermined rotation angle when the front passenger seat side wiper blade wipes a wider range than the wiping range Z1 (for example, the wiping range Z2).

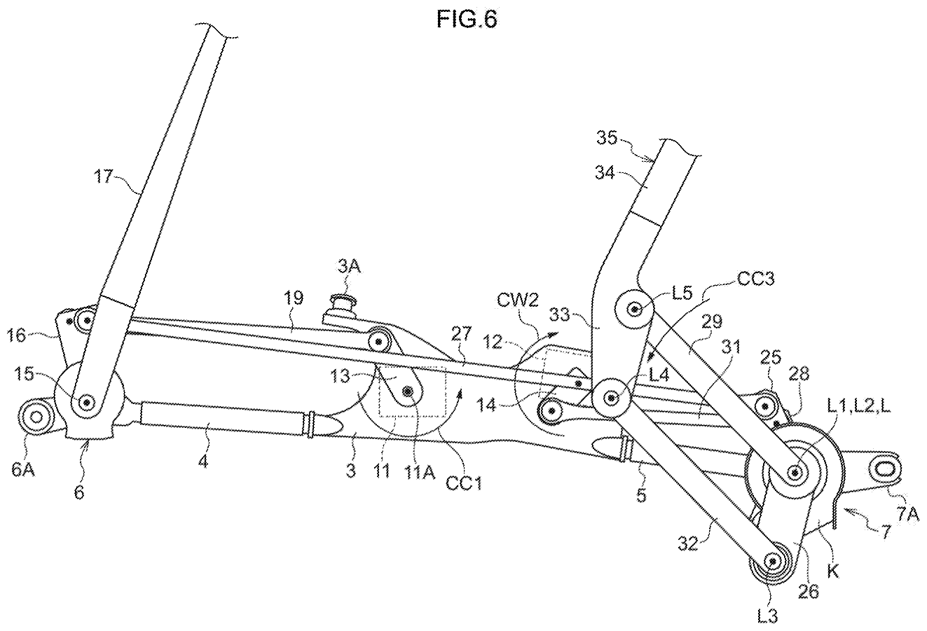

FIG. 6 illustrates a case in which the first drive lever 26 has rotated further, such that the front passenger seat side wiper blade 36 has covered approximately three quarters of the stroke (outward stroke) between the lower return position P2P and the upper return position P1P. In FIG. 6, the rotation direction of the first output shaft 11A of the first motor 11 is the same as that in FIG. 4 and FIG. 5, but the second output shaft 12A of the second motor 12 is rotating in a rotation direction CW2 (rotating in reverse), this being the opposite direction to that in FIG. 4 and FIG. 5. The rotation of the second output shaft 12A in the rotation direction CW2 operates the second drive lever 29 in an operation direction CC3, such that the fifth axis L5 configuring the pivot point of the front passenger seat side wiper arm 35 moves downward from the second position. As a result, the front passenger seat side wiper blade 36 moves across the windshield glass 1 such that the leading end portion of the front passenger seat side wiper blade 36 describes the trajectory illustrated by dashed lines above the wiping range Z2 illustrated in FIG. 1, thus wiping the wiping range Z2.

FIG. 7 illustrates a case in which the first output shaft 11A of the first motor 11 has rotated forward by the first predetermined rotation angle, and the second output shaft 12A of the second motor 12 has rotated in reverse by the second predetermined rotation angle. The first output shaft 11A of the first motor 11 has reached its maximum rotation angle for forward rotation, such that the driver's seat side wiper arm 17 and the driver's seat side wiper blade 18 reach the upper return position P1D. The second output shaft 12A of the second motor 12 has rotated in reverse by the second predetermined rotation angle from the state illustrated in FIG. 5 (a state in which the second output shaft 12A has rotated forward by the second predetermined rotation angle), such that the fifth axis L5 configuring the pivot point of the front passenger seat side wiper arm 35 has returned to the first position illustrated in FIG. 2, this being the position of the fifth axis L5 prior to the start of forward rotation of the second output shaft 12A of the second motor 12. As a result, the front passenger seat side wiper arm 35 and the front passenger seat side wiper blade 36 reach the same upper return position P1P as that of the wiping range Z1 in cases in which the second motor 12 is not driven.

FIG. 8 illustrates a slate on a return journey (return stroke) in which the driver's seat side wiper arm 17 and the driver's seat side wiper blade 18, and the front passenger seat side wiper arm 35 and the front passenger seat side wiper blade 36, move from the upper return positions P1D, P1P to the lower return positions P2D. P2P. On the return journey, the first output shaft 11A of the first motor 11 rotates in reverse, rotating in the rotation direction CW1, this being the opposite direction to that in FIG. 2 and FIG. 4 to FIG. 7. The second output shaft 12A of the second motor 12 does not rotate, and the fifth axis L5 configuring the pivot point of the from passenger seat side wiper arm 35 accordingly does not move from the first position. The front passenger seat side wiper arm 35 accordingly describes a substantially circular are shaped trajectory due to the reverse rotation of the first output shaft 11A of the first motor 11. As a result, the front passenger seat side wiper blade 36 coupled to the leading end of the front passenger seat side wiper arm 35 wipes the wiping range Z1.

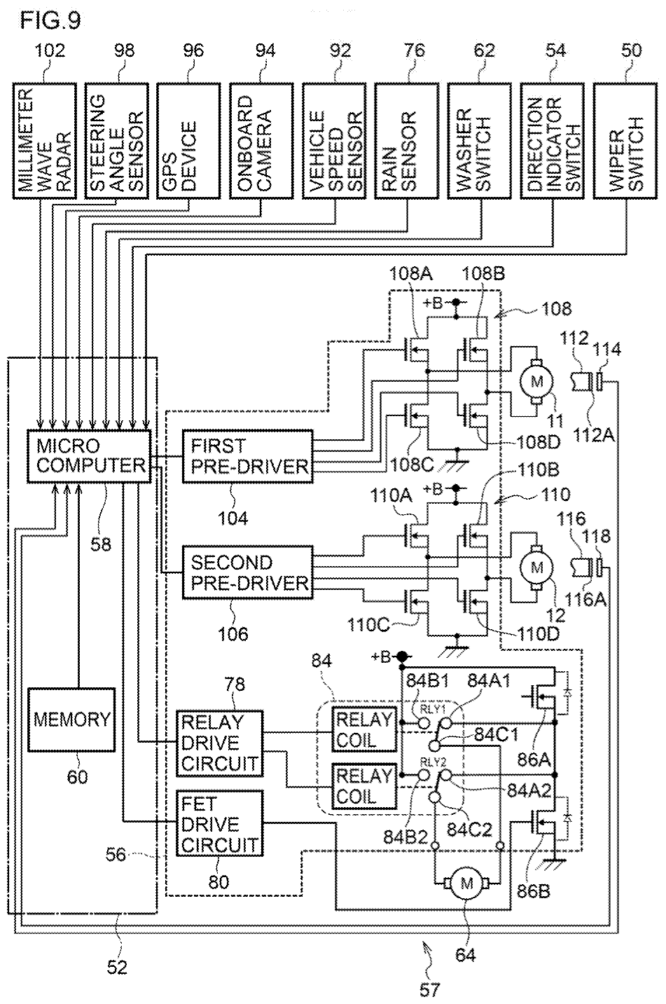

FIG. 9 is a circuit diagram schematically illustrating circuits of the wiper system 100 according to the first exemplary embodiment. As illustrated in FIG. 9, the wiper system 100 includes the control circuit 52 and the drive circuit 56.

The control circuit 52 includes the microcomputer 58 and the memory 60 as described above. The wiper switch 50. the direction indicator switch 54. the washer switch 62. the rain sensor 76, the vehicle speed sensor 92, the onboard camera 94, the OPS device 96, the steering angle sensor 98, and the millimeter wave radar 102 are respectively connected to the microcomputer 58 through the vehicle ECU 90 (not illustrated in the drawing).

The drive circuit 56 includes a first pre-driver 104 and a first motor drive circuit 108 to drive the first motor 11, and a second pre-driver 106 and a second motor drive circuit 110 to drive the second motor 12. The drive circuit 56 further includes a relay drive circuit 78, a FET drive circuit 80, and a washer motor drive circuit 57 to drive the washer motor 64.

The microcomputer 58 of the control circuit 52 respectively controls rotation of the first motor 11 by using the first pre-driver 104 to switch ON and OFF switching elements configuring the first motor drive circuit 108, and controls rotation of the second motor 12 by using the second pre-driver 106 to switch ON and OFF switching elements of the second motor drive circuit 110. The microcomputer 58 also controls the relay drive circuit 78 and the FET drive circuit 80 in order to control rotation of the washer motor 64.

In cases in which the first motor 11 and the second motor 12 are configured by brushed DC motors, the first motor drive circuit 108 and the second motor drive circuit 110 each include four switching elements. The switching elements are, for example, N-type field effect transistors (FETs).

As illustrated in FIG. 9, the first motor drive circuit 108 includes FETs 108A to 108D, The drain of the FET 108A is connected to a power source (+B), the gate of the FET 108A is connected to the first pre-driver 104, and the source of the FET 108A is connected to one end portion of the first motor 11. The drain of the FET 108B is connected to the power source the gate of the FET 108B is connected to the first pre-driver 104. and the source of the FET 108B is connected to the other end portion of the first motor 11. The drain of the FET 108C is connected to the one end portion of the first motor 11, the gate of the FET 108C is connected to the first pre-driver 104, and the source of the FET 108C is connected to ground. The drain of the FET 108D is connected to the other end portion of the first motor 11, the gate of the FET 108D is connected to the first pre-driver 104, and the source of the FET 108D is connected to ground.

The first pre-driver 104 switches control signals supplied to the gates of the FETs 108A to 108D according to control signals from the microcomputer 58 in order to control drive of the first motor 11. Namely, in order to rotate the first output shaft 11A of the first motor 11 in a predetermined direction (forward rotation), the first pre-driver 104 switches ON the FET 108A and the FET 108D as a pair, and in order to rotate the first output shaft 11A of the first motor 11 in the opposite direction to the predetermined direction (reverse rotation), the first pre-driver 104 switches ON the FET 108B and the FET 108C as a pair. The first pre-driver 104 also performs PWM to switch the FET 108A and the FET 108D ON and OFF intermittently based on control signals from the microcomputer 58.

The first pre-driver 104 uses PWM to vary the ON/OFF duty ratio of the FET 108A and the FET 108D in order to control the rotation speed of forward rotation of the first motor 11. The higher the duty ratio, the higher the effective value of the voltage applied to the terminal of the first motor 11 during forward rotation, and the greater the rotation speed of the first motor 11.

Similarly, the first pre-driver 104 uses PWM to vary the ON/OFF duty ratio of the FET 108B and the FET 108C in order to control the rotation speed of reverse rotation of the first motor 11. The higher the duty ratio, the higher the effective value of the voltage applied to the terminal of the first motor 11 during reverse rotation, and the greater the rotation speed of the first motor 11.

The second motor drive circuit 110 includes FETs 110A to 110D. The dram of the FET 110A is connected to a power source (+B). the gate of the FET 110A is connected to the second pre-driver 106, and the source of the first output shaft 11A is connected to one end portion of the second motor 12. The drain of the FET 11 OB is connected to the power source (+B), the gate of the FET 110B is connected to the second pre-driver 106, and the source of the FET 110B is connected to the other end portion of the second motor 12. The drain of the FET 110C is connected to the one end portion of the second motor 12, the gate of the FET 110C is connected to the second pre-driver 106, and the source of the FET 110C is connected to ground. The drain of the FET 110D is connected to the other end portion of the second motor 12, the gate of the FET 110D is connected to the second pre-driver 106, and the source of the FET 110D is connected to ground.

The second pre-driver 106 switches control signals supplied to the gates of the FETs 110A to 110D according to control signals from the microcomputer 58 in order to control drive of the second motor 12. Namely, in order to rotate the second output shaft 12A of the second motor 12 in a predetermined direction (forward rotation), the second pre-driver 106 switches ON the FET 110A and the FET 110D as a pair, and in order to rotate the second output shaft 12A of the second motor 12 in the opposite direction to the predetermined direction (reverse rotation), the second pre-driver 106 switches ON the FET 110B and the FET 110C as a pair. The second pre-driver 104 also performs PWM similar to that of the first pre-driver 104 described above in order to control the rotation speed of the second motor 12 based on control signals from the microcomputer 58.

A bipolar sensor magnet 112A is fixed to an output shaft end portion 112 of the first output shaft 11A inside the speed reduction mechanism of the first motor 11. A first absolute angle sensor 114 is provided lacing the sensor magnet 112A.

A bipolar sensor magnet 116A is fixed to an output shaft end portion 116 of the second output shaft 12A inside the speed reduction mechanism of the second motor 12. A second absolute angle sensor 118 is provided facing the sensor magnet 116A.

The first absolute angle sensor 114 detects the magnetic field of the sensor magnet 112A, and the second absolute angle sensor 118 detects the magnetic field of the sensor magnet 116A, and the first absolute angle sensor 114 and the second absolute angle sensor 118 output signals corresponding to the strength of the detected magnetic fields. The microcomputer 58 computes the rotation angles, rotation positions, rotation directions, and rotation speeds of the first output shaft 11A of the first motor 11 and that of the second motor 12 based on the respective signals output by the first absolute angle sensor 114 and the second absolute angle sensor 118.

The position of the driver's seat side wiper blade 18 between the lower return position P2D and the upper return position P1D can be computed from the rotation angle of the first output shaft 11A of the first motor 11. Moreover, the degree of apparent extension (degree of change) of the front passenger seat side wiper arm 35 can be computed from the rotation angle of the second output shaft 12A of the second motor 12. The microcomputer 58 controls the rotation angle of the second output shaft 12A based on the position of the driver's seat side wiper blade 18 between the lower return position P2D and the upper return position P1D computed from the rotation angle of the first output shaft 11A in order to synchronize the operation of the first motor 11 and the second motor 12. As an example, the memory 60 is stored in advance with a map in which positions of the driver's seat side wiper blade 18 between the lower return position P2D and the upper return position P1D (or rotation angles of the first output shaft 11A) are associated with rotation angles of the second output shaft 12A (for example, a second output shaft rotation angle map, described later), and the rotation angle of the second output shaft 12A is controlled so as to correspond to the rotation angle of the first output shaft 11A according to this map.

The washer motor drive circuit 57 includes two relays RLY1, RLY2 built into a relay unit 84, and two FETs 86A, 86B. Relay coils of the relays RLY1, RLY2 of the relay unit 84 are respectively connected to the relay drive circuit 78. The relay drive circuit 78 switches the relays RLY1, RLY2 ON and OFF (excites and ceases excitation of the relay coils). When the relay coils of the relays RLY1, RLY2 are not being excited, common terminals 840, 84C2 maintain respective connected states to first terminals 84A1, 84A2 (OFF states), and when the relay coils are excited, the common terminals 84C1, 84C2 switch to respective connected states with second terminals 84B1, 84B2. The common terminal 84C1 of the relay RLY1 is connected to one end of the washer motor 64, and the common terminal 84C2 of the relay RLY2 is connected to the other end of the washer motor 64. Moreover, the first terminals 84A1, 84A2 of the respective relays RLY1, RLY2 are connected to the drain of the FET 86B, and the second terminals 84B1, 84B2 of the respective relays RLY1, RLY2 are connected to a power source (+B).

The gate of the FET 86B is connected to the FET drive circuit 80, and the source of the FET 86B is connected to ground. The ON/OFF duty ratio of the FET 86B is controlled by the FET drive circuit 80. The FET 86A is provided between the drain of the FET 86B and the power source (+B). The gate of the FET 86A is not input with control signals, and so the FET 86A is not switched ON and OFF, instead being provided as a parasitic diode to absorb surges.

The relay drive circuit 78 and the FET drive circuit 80 switch the two relays RLY1, RLY2 and the FET 86B ON and OFF in order to control drive of the washer motor 64. Namely, in order to rotate an output shaft of the washer motor 64 in a predetermined direction (forward rotation), the relay drive circuit 78 swatches ON the relay RLY1 (the relay RLY2 is OFF), and the FET drive circuit 80 switches the FET 86B ON at a predetermined duty ratio. The above control controls the rotation speed of the output shaft of the washer motor 64.

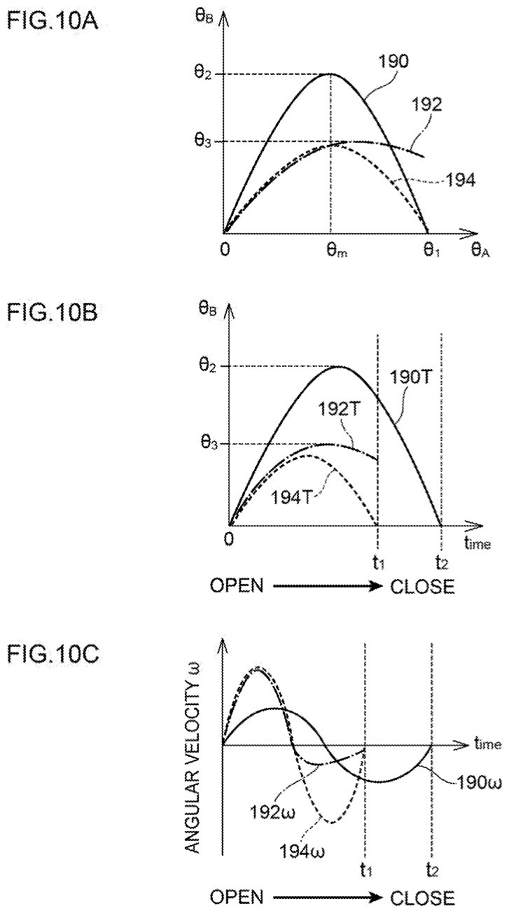

FIG. 10A illustrates an example of second output shaft rotation angle maps that define rotation angles of the second output shaft 12A according to rotation angles of the first output shaft 11A in the first exemplary embodiment. The horizontal axis in FIG. 10A represents first output shaft rotation angles θ_{A} configuring rotation angles of the first output shaft 11A, and the vertical axis represents second output shaft rotation angles θ_{B} configuring rotation angles of the of the second output shaft 12A. The origin O in FIG. 10A represents a state in which the front passenger seat side wiper blade 36 is at the lower return position P2P. θ₁ in FIG. 10A represents a state in which the first output shaft 11A has rotated by a first predetermined rotation angle θ₁, and the front passenger seat side wiper blade 36 is at the upper return position P1P.

When the first absolute angle sensor 114 the first output shaft 11A of the first motor 11 starts to rotate, the microcomputer 58 compares the rotation angle of the first output shaft 11A detected by the first absolute angle sensor 114 against the second output shaft rotation angle map. This comparison is used to compute the second output shaft rotation angle θ_{B} corresponding to the first output shaft rotation angle θ_{A} detected by the first absolute angle sensor 114 using the angle indicated by the curve 190 in FIG. 10A, and the rotation angle of the second output shaft 12A of the second motor 12 is controlled so as to become the computed second output shaft rotation angle θ_{B}. In FIG. 10A, the curves 190, 192, 194 illustrate three second output shaft rotation angle maps. The curve 190 represents rotation angles of the second output shaft 12A determined according to the first output shaft rotation angle θ_{A} when wiping the wiping range Z2 with a change ratio of 100%. For the curve 190, when the first output shaft rotation angle θ_{A} is an intermediate rotation angle θₘ, the second output shaft rotation angle θ_{B} is at a maximum second predetermined rotation angle θ₂. The curve 192 represents rotation angles of the second output shaft 12A determined according to the first output shaft rotation angle θ_{A} when wiping the wiping range Z3. For the curve 192, the second output shaft rotation angle θ_{B} is at a maximum angle θ₃ when the first output shaft rotation angle θ_{A} is between the intermediate rotation angle θₘ and the first predetermined rotation angle θ₁. As an example, the curve 194 represents rotation angles of the second output shaft 12A determined according to the first output shaft rotation angle θ_{A} with a change ratio of 50%.

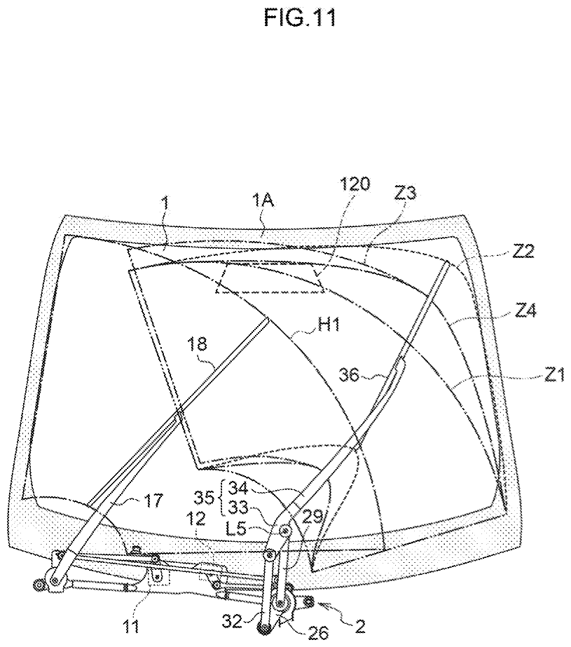

FIG. 11 is a schematic diagram illustrating an example of wiping ranges according to the second output shaft rotation angle maps illustrated in FIG. 10A. The wiping range Z1 is a wiping range in a case in which the change ratio is 0%, namely in a case in which the front passenger seat side wiper arm 35 has not been extended. The wiping range Z2 is the wiping range when employing the curve 190 illustrated in FIG. 10A, with a change ratio of 100%. The wiping range Z3 is the wiping range when employing the curve 192. The wiping range Z4 is the wiping range when employing the curve 194, with a change ratio of 50%. Since θ₂>θ₃, the change ratio range is greater when employing the curve 190 and wiping the wiping range Z2 than when employing the curve 192 and wiping the wiping range Z3. When wiping the wiping range Z2, the extension of the extension and retraction mechanism configured by the first drive lever 26, the second drive lever 29, the first following lever 32, and the arm head 33 is at a maximum when the front passenger seat side wiper blade 36 is wiping a location corresponding to the upper corner of the front passenger seal side of the windshield glass 1, specifically in the vicinity of an intermediate position between the lower return position P2P and the upper return position P1P. When wiping the wiping range Z3, the extension of the extension and retraction mechanism is at a maximum when the front passenger seal side wiper blade 36 is positioned between a location corresponding to the upper corner of the front passenger seat side of the windshield glass 1 and the upper return position P1P, specifically between the vicinity of the intermediate position between the lower return position P2P and the upper return position P1P, and the upper return position P1P.

As illustrated in FIG. 10A, the curve 192 diverges from the curve 194 near the location where the first output shaft rotation angle θ_{A} becomes the intermediate rotation angle θₘ between 0° and the first predetermined rotation angle θ₁. After diverging at the intermediate rotation angle θₘ, on the curve 194, the second output shaft rotation angle θ_{B} decreases monotonically as the first output shaft rotation angle θ_{A} approaches the first predetermined rotation angle θ₁, and the second output shaft rotation angle θ_{B} returns to 0 when the first output shaft rotation angle θ_{A} becomes the first predetermined rotation angle θ₁. However, on the curve 192, after diverging from the curve 194 at the intermediate rotation angle θₘ, although the second output shaft rotation angle θ_{B} decreases monotonically as the first output shaft rotation angle θ_{A} approaches the first predetermined rotation angle θ₁, the decrease is not as large as on the curve 194, such that the second output shaft rotation angle θ_{B} does not return to 0 even when the first output shaft rotation angle θ_{A} becomes the first predetermined rotation angle θ₁. As a result, as illustrated in FIG. 11, the wiping range Z3 enables the upper side of the windshield glass 1 to be wiped over a wider range than the wiping ranges Z2, Z4.

FIG. 10B illustrates an example of variation over time of the rotation angle of the second output shaft 12A in the first exemplary embodiment. The horizontal axis in FIG. 10B represents time, and the vertical axis represents the second output shaft rotation angle θ_{B}, this being the rotation angle of the second output shaft 12A. FIG. 10B illustrates variation of the second output shaft rotation angle θ_{B} over time in a case in which the front passenger seat side wiper blade 36 travels on the outward wiping path (OPENS), and then travels on the return wiping path (CLOSES).

The curve 190T in FIG. 10B corresponds to live curve 190 in FIG. 10A, and principally illustrates variation of the second output shaft rotation angle θ_{B} over time in a case in which the wiper switch 50 is at the low speed operation mode selection position, in the low speed operation mode, the to-and-fro wiping operation between the lower return position P2P and the upper return position P1P takes longer than in the high speed operation mode Accordingly, the curve 190T is defined from a time 0 until a time t2 that is later than a time t1.

The curves 192T, 194T in FIG. 10B respectively correspond to the curves 192, 194 in FIG. 10A, and principally illustrate variation of the second output shaft rotation angle θ_{B} over time in a case in which the wiper switch 50 is at the high speed operation mode selection position. In the high speed operation mode, the to-and-fro wiping operation between the lower return position P2P and the upper return position P1P is completed in a shorter time than in the low speed operation mode. Accordingly, the curves 192T, 194T are defined from the time t0 until the time t1 that is prior to the time t2. In FIG. 10B, the second output shaft rotation angle θ_{B} returns to 0 at the time t1 on the curve 194T. On the curve 192T, there is no return to 0 at the time t1, such that the front passenger seat side wiper arm 35 reaches the upper return position P1P in an extended state.

FIG. 10C illustrates an example of variation over time in angular velocity ω of the second output shaft 12A in the first exemplary embodiment. The horizontal axis in FIG. 10C represents time, and the vertical axis represents the angular velocity ω of the second output shaft 12A. In FIG. 10C, the curves 190ω, 192ω, 194ω respectively correspond to the curves 190, 192, 194 illustrated in FIG. 10A.

Since the angular velocity ω is a vector amount, the sign of the angular velocity ω is inverted when the second output shaft 12A rotates in the opposite direction after having rotated in one direction. In the cases of the curves 190ω, 194ω, since the absolute value of the variation amount of the rotation angle in the one direction and the absolute value of the variation amount of the rotation angle in the other direction are substantially equal to each other, the upward pointing convex portion and the downward pointing convex portion of the curve exhibit substantially the same amplitude and period to each other. In the case of the curve 192ω, since the opposite direction rotation of the second output shaft 12A after rotating in the one direction is suppressed in comparison to the case of the curve 194ω, the downward pointing convex portion has a smaller amplitude than the upward pointing convex portion.

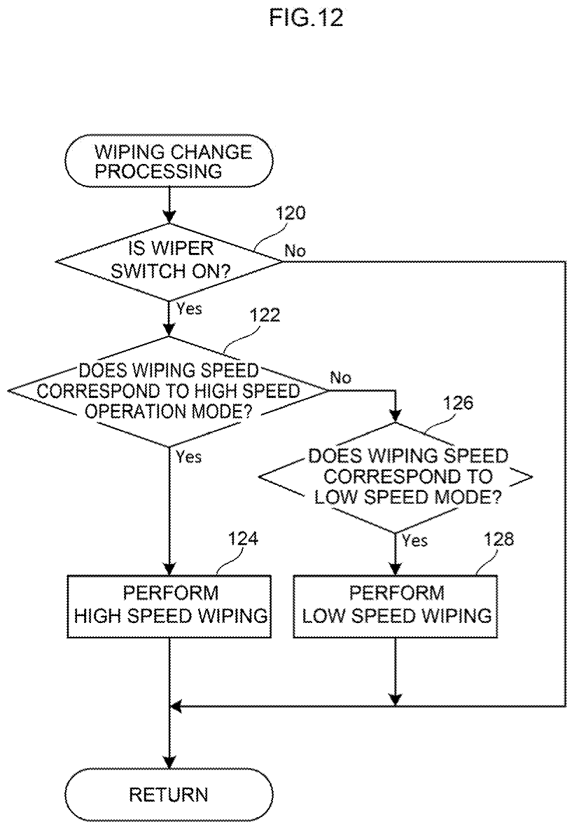

Explanation follows regarding control of the wiper system 100 according to the first exemplary embodiment. FIG. 12 is a flow chart illustrating an example of wiping change processing in the wiper system 100 according to the first exemplary embodiment. At step 120, determination is made as to whether or not the wiper switch 50 has been switched ON. Processing transitions to step 122 in cases in which determination is affirmative, and processing returns in cases in which determination is negative.

At step 122, determination is made as to whether or not the wiping speed corresponds to a high speed operation mode. At step 122, determination is affirmative in cases in which the wiper swatch 50 is at the high speed operation mode selection position. Determination is also affirmative in cases in which the wiper switch 50 is at the AUTO operation mode selection position and a rotation speed of the first output shaft 11A computed from the first output shaft rotation angle θ_{A} detected by the first absolute angle sensor 114 corresponds to that of the high speed operation mode.

In cases in which determination is affirmative at step 122, at step 124, the rotation angle of the second output shaft 12A is controlled using the second output shaft rotation angle map corresponding to the curve 192 illustrated in FIG. 10A. A change to high speed wiping is performed to wipe the wiping range Z3 illustrated in FIG. 1 and FIG. 11, and then processing returns.

In cases in which determination is negative at step 122, at step 126, determination is made as to whether or not the wiping speed corresponds to that of the low speed operation mode. Determination is affirmative at step 122 in cases in which the wiper switch 50 is at the low speed operation mode selection position. Determination is also affirmative in cases in which the wiper switch 50 is at the AUTO operation mode selection position and a rotation speed of the first output shaft 11A computed from the first output shaft rotation angle θ_{A} detected by the first absolute angle sensor 114 corresponds to that of the low speed operation mode.

In cases in which determination is affirmative at step 126, at step 128, the rotation angle of the second output shaft 12A is controlled using the second output shaft rotation angle map corresponding to the curve 190 illustrated in FIG. 10A. A change to low speed wiping is performed to wipe the wiping range Z2 illustrated in FIG. 1 and FIG. 11, and then processing returns.

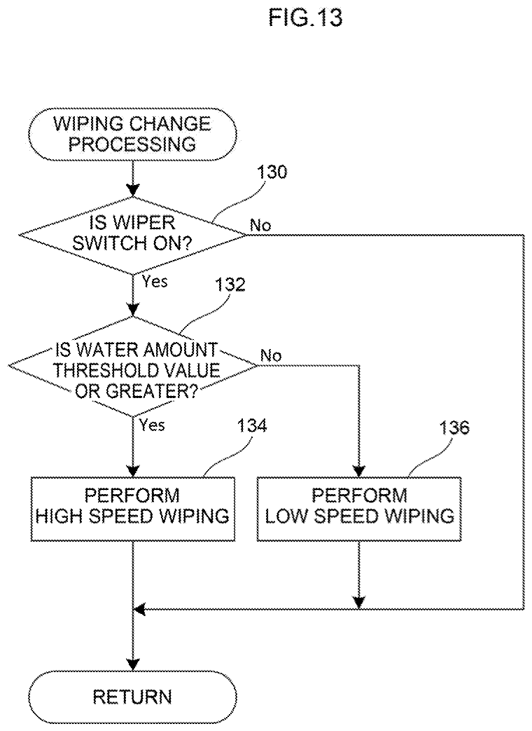

FIG. 13 is a flowchart illustrating another example of wiping change processing in the wiper system 100 according to the first exemplary embodiment. At step 130, determination is made as to whether or not the wiper switch 50 has been switched ON. Processing transitions to step 122 in cases in which determination is affirmative, and processing returns in cases in which determination is negative.

At step 132, determination is affirmative in cases in which an amount of water on the windshield glass 1 detected by the rain sensor 76 corresponds for example to a moderate amount of rain equivalent to 10 mm of rain per hour.

In cases in which determination is affirmative at step 132, at step 134, the wiping speed is set equivalent to that of the high speed operation mode, and the rotation angle of the second output shaft 12A is controlled using the second output shaft rotation angle map corresponding to the curve 192 illustrated in FIG. 10A to perform a change to high speed wiping to wipe the wiping range Z3 illustrated in FIG. 1 and FIG. 11, and then processing returns.

In cases in which determination is negative at step 132, at step 136, the wiping speed is set equivalent to that of the low speed operation mode, and the rotation angle of the second output shaft 12A is controlled using the second output shaft rotation angle map corresponding to the curve 190 illustrated in FIG. 10A to perform a change to low speed wiping to wipe the wiping range 11 illustrated in FIG. 1 and FIG. 11 and then processing returns.

As described above, in the first exemplary embodiment, the level of change to the wiping range can be changed according to circumstances by employing the second output shaft rotation angle maps represented by the curves 190, 192. For example, in cases in which a large amount of water is present on the windshield glass 1 and the wiping speed is set fast, the second output shaft rotation angle map corresponding to the curve 192 illustrated in FIG. 10A is employed to control the rotation angle of the second output shaft 12A and wipe the wiping range Z3 illustrated in FIG. 1 and FIG. 11. This thereby enables a wide area including the functional area 120 where the rain sensor 70 and the onboard camera 94 are provided to be wiped. In cases in which the amount of water on the windshield glass 1 is not especially large and there is no need for a fast wiping speed, the rotation angle of the second output shaft 12A is controlled employing the second output shaft rotation angle map corresponding to the curve 190 illustrated in FIG. 10A to wipe the wiping range Z2 illustrated in FIG. 1 and FIG. 11. This thereby enables the front passenger seat side portion of the windshield glass 1 to be wiped over a wide range.

One feature of the first exemplary embodiment is that the change ratio is smaller when the wiping speed is fast than when the wiping speed is slow. However, the change ratio is not simply reduced. Namely, when the wiping speed is slow, the second output shaft rotation angle map follows the curve 190 with a change ratio of 100%. However, when the wiping speed is fast, instead of simply lowering the change ratio to 50% such that the second output shaft rotation angle map follow s the curve 194, as in the curve 192, the second output shaft rotation angle θ_{B} is varied more gently than the curve 194 on progression from the intermediate rotation angle θₘ toward the upper return position, such that the second output shaft rotation angle docs not become 0 (is in an extended slate) at the upper return position.

In the first exemplary embodiment, the detection result of the rain sensor 76 is utilized to change the change in wiping range according to circumstances. As well as the detection results of the rain sensor 76, in cases in which the vehicle speed detected by the vehicle speed sensor 92 is a specific value or greater, the wiping speed may be set fast and the wiping range Z3 illustrated in FIG. 1 and FIG. 11 may be wiped so as to actively remove water droplets from the functional area 120.

Moreover, the wiping range Z3 may be wiped in cases in which foreign material such as snow, ice, or mud is determined to be present on the windshield glass 1 from the image data acquired by the onboard camera 94. Alternatively, in cases in which the GPS device 96 has detected that the vehicle is approaching an intersection and a vehicle steering angle detected by the steering angle sensor 98 is above a predetermined threshold value or the direction indicator switch has been operated, determination may be made that it is necessary to secure a broad field of view from the driver's seal, and the wiping range Z2 may be wiped. Furthermore, in cases in which an obstacle has been discovered ahead or to the side by the millimeter wave radar 102, the wiping range Z2 may be wiped in order to secure a broad field of view from the driver's seat.

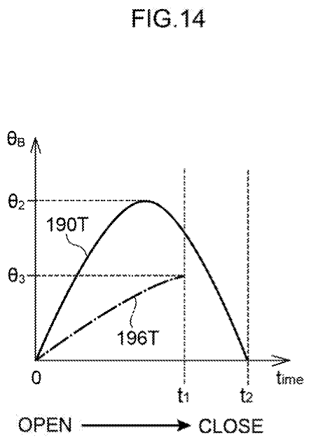

Explanation has been given regarding operation of the wiper system 100 according to the first exemplary embodiment based on the second output shaft rotation angle maps illustrated in FIG. 10. However, the second output shaft rotation angle maps are not limited to those illustrated in FIG. 10. FIG. 14 is a schematic diagram illustrating second output shaft rotation angle maps of a modified example of the first exemplary embodiment. In FIG. 14, the curve 196T represents variation in the second output shaft rotation angle θ_{B} from the time 0 to time t1. Unlike the curve 192T in FIG. 10B, the second output shaft rotation angle θ_{B} expresses a monotonic increasing trend until the time t1. By employing the curve 196T, the extension of the extension and retraction mechanism configured by the first drive lever 26, the second drive lever 29, the first following lever 32, and the arm head 33 is at a maximum in the vicinity of the upper return position P1P.

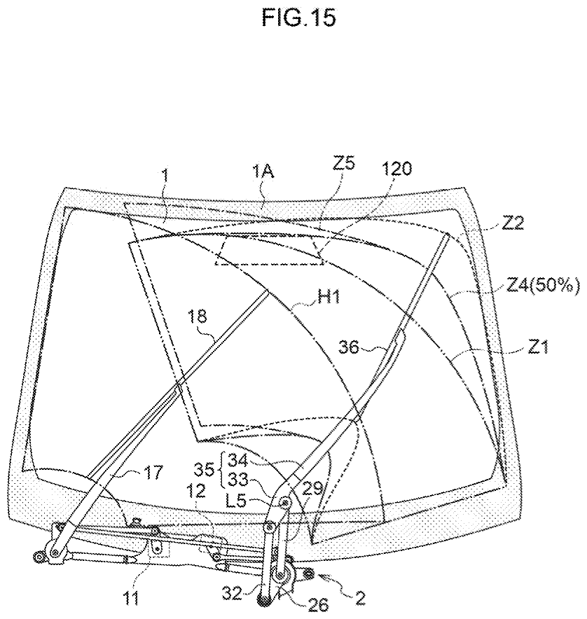

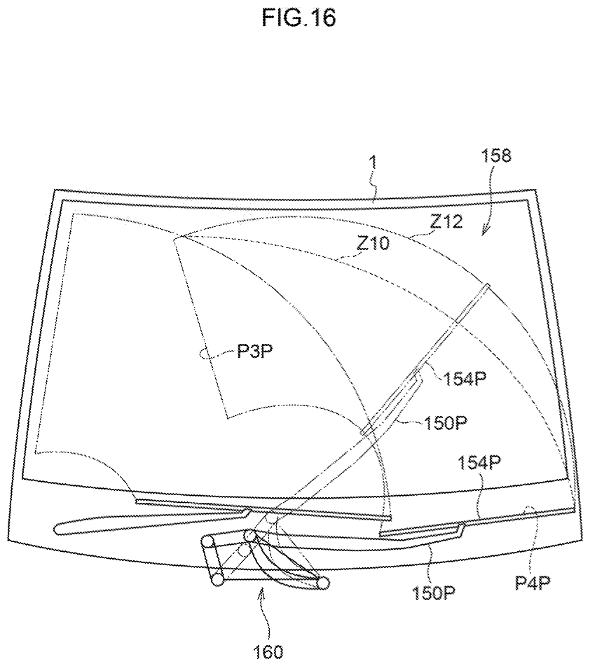

FIG. 15 is an explanatory diagram illustrating a wiping range Z5 in cases in which the second output shaft rotation angle map corresponding to the curve 196T illustrated in FIG. 14 is employed. By employing the second output shaft rotation speed map corresponding to the curve 196T that represents a monotonic increasing trend until the time t1. the wiping range Z5 enables the upper portion of the windshield glass 1 to be wiped over a wider range than the wiping range Z3 illustrated in FIG. 1 and FIG. 11.

### Second Exemplary Embodiment

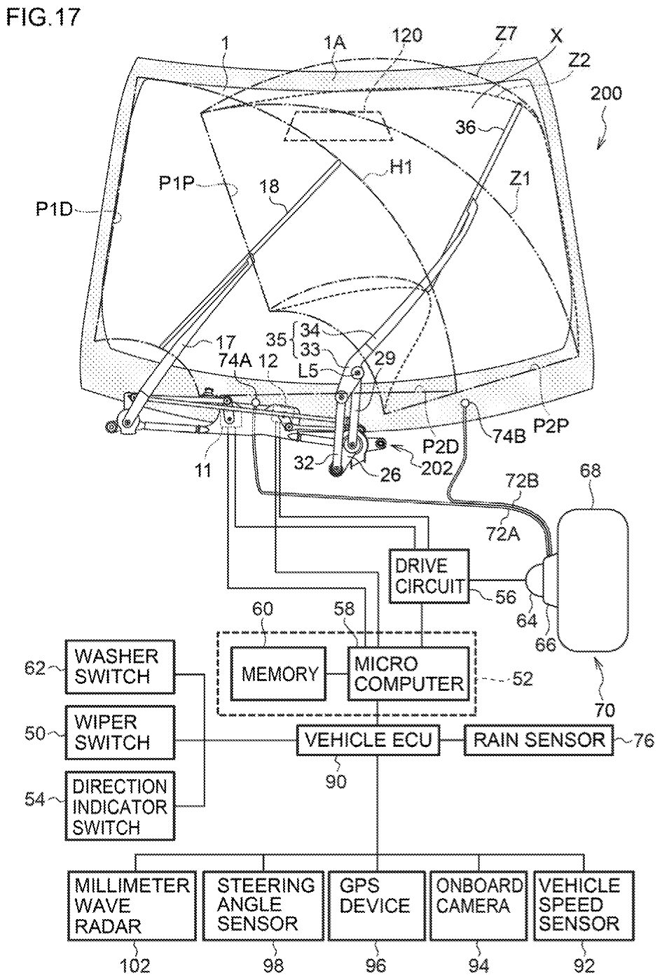

FIG. 17 is a schematic diagram illustrating an example of a wiper system 200 including a wiper device 202 according to a second exemplary embodiment of the present disclosure. The following explanation focuses on sections that differ from the first exemplary embodiment, and so explanation regarding configurations similar to those of the first exemplary embodiment is omitted.

In the first exemplary embodiment described above, the range of the windshield glass wiped by the front passenger seat side wiper blade 36 is changed between the wiping range Z1 and the wiping range Z2. In the second exemplary embodiment, the size of the second predetermined rotation angle is changed such that the leading end portion of the front passenger seat side wiper blade 36 travels beyond the outer edge portion of the windshield glass 1. As a result, the second exemplary embodiment enables a wiping range Z7 illustrated in FIG. 17 to be wiped by the front passenger seat side wiper blade 36.

In the second exemplary embodiment, in cases in which the wiper switch 50 is at the low speed operation mode selection position to operate the driver's seat side wiper blade 18 and the front passenger seat side wiper blade 36 at low speed, the wiping range Z2 is wiped in principle, and in cases in which the wiper switch 50 is at the high speed operation mode selection position to operate the drivers seal side wiper blade 18 and the front passenger seal side wiper blade 36 at high speed, the wiping range Z1 is wiped in principle. If extension of the front passenger seat side wiper arm 35 is performed rapidly in a high speed wiping operation, there is a concern that the load on the link mechanism to extend the front passenger seat side wiper arm 35 and on the second motor 12 could become large, and that rushed extension of the front passenger seat side wiper arm 35 could distract a user. However, if only the wiping range Z1 is wiped, water droplets tend to collect in the non-wiped range X, and these water droplets might flow down into the wiping range Z1 to form rain trickles. In the second exemplary embodiment, in a final wipe when the wiper switch 50 has been switched OFF and the wiping operation is stopped, the wiping range Z7 is wiped to remove water droplets that have collected in the non-wiped range X, thereby preventing rain from trickling into the wiping ranges Z1, Z2. Note that rain trickles are more liable to become an issue after completing a wiping operation when the wiping range Z1 was being wiped. However, in the second exemplary embodiment, the wiping range Z7 is also wiped to prevent rain trickles in a final wiping operation before stopping the wiping operation in cases in which the wiping range Z2 was being wiped.

In the second exemplary embodiment, in cases in which it is necessary to wipe the windshield glass 1 over a wide range, the first motor 11 and the second motor 12 are respectively controlled so as to wipe the wiping range Z2 or the wiping range Z7 on the outward journey (on the outward wiping path) as the front passenger seat side wiper blade 36 travels from the lower return position P2P toward the upper return position P1P. The first motor 11 and the second motor 12 are respectively controlled so as to wipe the wiping range Z1 on the return journey (on the return wiping path) after the front passenger seat side wiper blade 36 has reversed direction at the upper return position P1P and travels toward the lower return position P2P. As the front passenger seat side wiper blade 36 travels to-and-fro between the lower return position P2P and the upper return position P1P. the wiping range Z2 is wiped on the outward journey, and the wiping range Z1 is wiped on the return journey, enabling the windshield glass 1 to be wiped over a wider range. Alternatively, as the front passenger seat side wiper blade 36 travels to-and-fro between the lower return position P2P and the upper return position P1P, the wiping range Z1 may be wiped on the outward journey, and the wiping range Z2 or the wiping range Z7 may be wiped on the return journey, also enabling the windshield glass 1 to be wiped over a wider range. Alternatively, the wiping range Z2 or the wiping range Z7 may be wiped both on the outward journey and on the return journey.

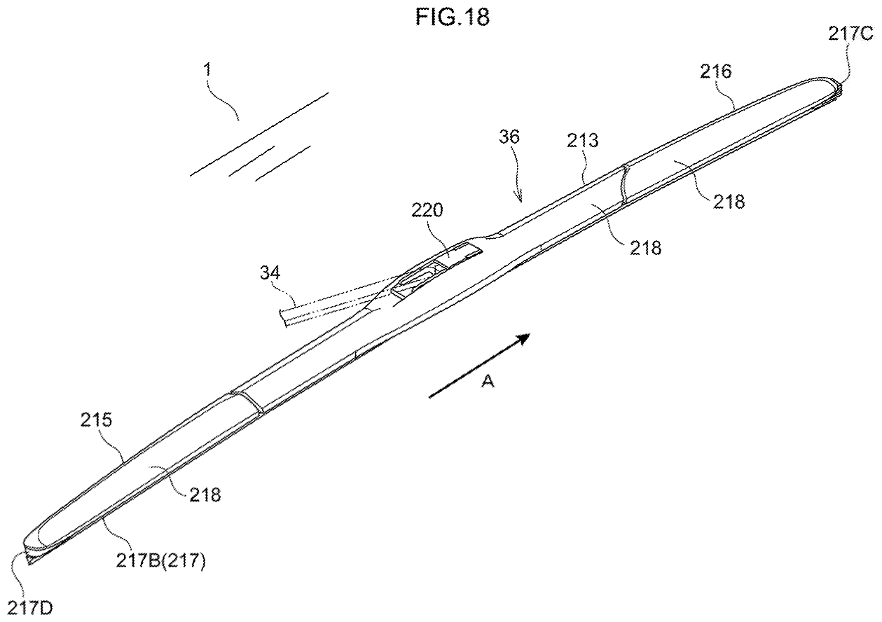

FIG. 18 is a schematic diagram illustrating an example of the front passenger seat side wiper blade 36 according to the second exemplary embodiment. In the second exemplary embodiment, the leading end portion of the front passenger seat side wiper blade 36 travels beyond the outer edge portion of the windshield glass 1 when wiping the wiping range Z7. Configuration is accordingly made to prevent the blade rubber from detaching as a result of interference with the outer edge portion.

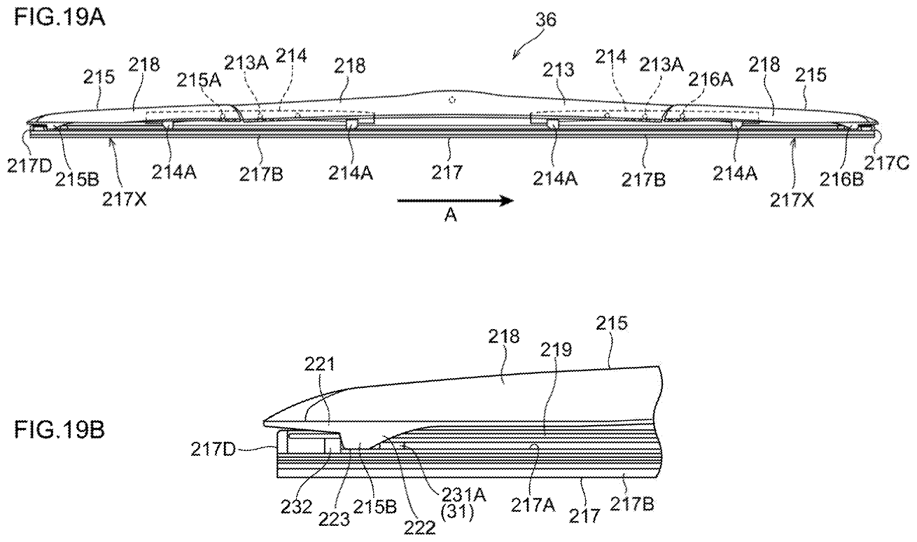

As illustrated in FIG. 18 and FIG. 19A, the front passenger seat side wiper blade 36 includes a main lever 213, two yoke levers 214, two movable cover members 215, 216 (cover members), and a blade rubber 217. Note that in the present exemplary embodiment, a rubber holder is configured by the main lever 213 and the yoke levers 214 in a configuration in which pressing force from the retainer 34 of the front passenger seat side wiper arm 35 is distributed along the length direction of the blade rubber 217.

The main lever 213 and the movable cover members 215, 216 are configured from a resin material, and the main lever 213 disposed at the length direction center of the front passenger seat side wiper blade 36 and the two movable cover members 215, 216 disposed on both length direction sides of the main lever 213 configure an outer shell of an upper portion of the front passenger seat side wiper blade 36. Note that of the two movable cover members 215, 216, the movable cover member 215 is disposed on a base end side of the from passenger seat side wiper blade 36 (on the side nearer the second output shaft 12A), and the movable cover member 216 is disposed on a leading end side of the front passenger seat side wiper blade 36.

The main lever 213 and the movable cover members 215, 216 are each formed with a inverted, substantially U-shaped cross-section profile opening toward the side of the windshield glass 1 in cross-section orthogonal to the length direction. The blade rubber 217, formed in an elongated shape from a rubber material, is disposed at the lower side of the main lever 213 and the movable cover members 215, 216 so as to run along the length direction of the main lever 213 and the movable cover members 215, 216. Note that the main lever 213 and the movable cover members 215, 216 are each formed with fins 218 to convert force received from wind during traveling into pressing force toward the windshield glass 1.

A central portion of the main lever 213 is detachably coupled to a leading end portion of the retainer 34 of the front passenger seat side wiper arm 35 through a coupling member 220 (see FIG. 18) so as to be capable of pivoting. Moreover, as illustrated in FIG. 19A, pivot shafts 213A are provided to both length direction end portions of the main lever 213. Central portions of the yoke levers 214 are assembled to the respective pivot shafts 213A, and the yoke levers 214 are supported so as to be capable of pivoting at both end portions of the main lever 213. An axis of each pivot shaft 213A runs parallel to the width direction of the front passenger seat side wiper blade 36 (a direction orthogonal to the page in FIG. 19A).

Base end portions of the movable cover members 215, 216 are assembled to respective pivot shafts 215A, 216A slightly to the length direction outsides than a pivot coupling portion at a central portion of each of the yoke levers 214. The movable cover members 215, 216 are thereby supported so as to be capable of pivoting with respect to the respective yoke levers 214. Grips 214A (holder-side retainers) are formed so as to configure a width direction pair at both end portions of each of the yoke levers 214. The blade rubber 217 is gripped by the grips 214A at predetermined spacings along the length direction.

As illustrated in FIG. 19B, a retention groove 217A is formed running along the length direction on both width direction sides of the blade rubber 217. The grips 214A of the yoke levers 214 am inserted into the corresponding retention grooves 217A. Backings 219 serving as a pair of plate spring members having an equivalent length direction length to the blade rubber 217 are mounted at positions at the upper sides of the retention grooves 217A of the blade rubber 217. A lip 217B that contacts the windshield glass 1 and that is capable of tilting with respect to its base portion is formed along the entire length direction at a position further toward the lower side than the retention grooves 217A of the blade rubber 217. Note that the backings 219 are each formed with a curved profile that curves so as to protrude toward the opposite side to the wiping surface at a central portion when in a natural state (non-loaded state), such that length direction end portions of the blade rubber 217 (following ends 217X, described later) elastically follow when pressed against the windshield glass 1.

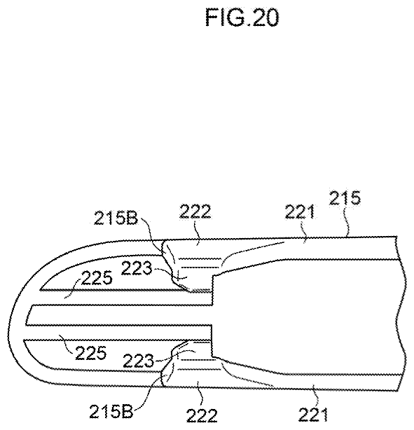

Retention claws 215B, 216B (cover-side retainers), each configuring a width direction pair, are formed at positions somewhat toward the length direction inside of leading end portions of the movable cover members 215, 216. The respective retention claws 215B, 216B each include an extension portion 222 extending downward (toward the windshield glass 1) from a side wall 221 on both width direction sides of the movable cover member 215 or the movable cover member 216, and an insertion portion 223 extending from a lower end of the extension portion 222 toward the width direction inside (see FIG. 20). The insertion portions 223 of the retention claws 215B, 216B are inserted into the retention grooves 217A of the blade rubber 217. The retention claws 215B, 216B are thus anchored to the retention grooves 217A in the height direction of the blade rubber 217.

Note that as illustrated in FIG. 20, a pair of abutting walls 225 that abut upper faces of the length direction end portions of the blade rubber 217 are formed extending downward from upper inner faces of the movable cover members 215, 216 at back sides of the leading end portions of the movable cover members 215, 216. The abutting walls 225 abut the end portions of the blade rubber 217 in the height direction, thereby restricting the end portions of the blade rubber 217 from entering the movable cover members 215, 216 by curving in the height direction.

The blade rubber 217 is attached to the movable cover members 215, 216 and the yoke levers 214 by inserting a leading end portion 217C of the blade rubber 217 (see FIG. 18 and FIG. 19A) along the arrow A in the length direction from the movable cover member 215 on the base end side. Specifically, the leading end portion 217C of the blade rubber 217 is inserted in sequence into the retention claws 215B of the movable cover member 215 on the base end side, the respective grips 214A of the yoke levers 214, and the retention claws 216B of the movable cover member 216 on the leading end side, such that the insertion portions 225 of the respective retention claws 215B, 216B and the respective grips 214A are inserted into the retention grooves 217A.

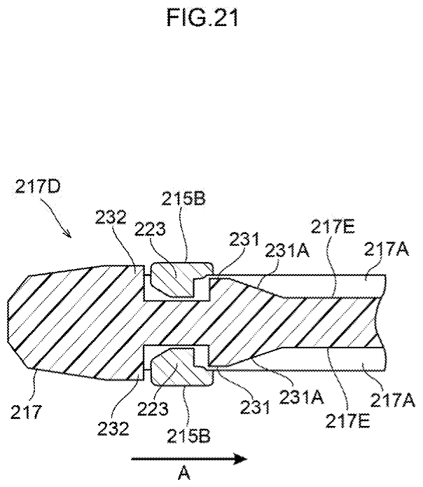

As illustrated in FIG. 21, a base end portion 217D configuring an end portion on the attachment direction-rear side of the blade rubber 217 is formed with anchor protrusions 231, serving as anchor portions projecting toward the width direction outsides from bottom portions 217E of the respective retention grooves 217A. A width direction projection amount of the anchor protrusions 231 is formed smaller than the depth of the retention grooves 217A. An inclined face 231A is formed at an attachment direction-front side of each of the anchor protrusions 231 so as to facilitate passage of the insertion portions 223 of the retention claws 215B of the base end side movable cover member 215 over the anchor protrusions 231.

The base end portion 217D of the blade rubber 217 is further formed with stoppers 232, serving as anchor portions, that project from the retention grooves 217A toward the width direction outsides at the attachment direction-rear side of the anchor protrusions 231 so as to block off the retention grooves 217A. A width direction projection amount of each of the stoppers 232 is formed larger than the projection amount of the anchor protrusions 231, and the stoppers 232 are formed so as to project to the width direction outsides of the retention grooves 217A. The base end portion 217D of the blade rubber 217 that is formed with the stoppers 232 has a shape bulging further toward both width direction sides than other locations of the blade rubber 217.

When the blade rubber 217 is inserted in the attachment direction, the insertion portions 223 of the retention claws 215B of the base end side movable cover member 215 abut the inclined faces 231A, and pass over by squashing the anchor protrusions 231 so as to lie disposed in recesses between the anchor protrusions 231 and the stoppers 232. The insertion portions 223 of the retention claws 215B are thereby anchored in the length direction of the blade rubber 217 with respect to the anchor protrusions 231 and the stoppers 232.

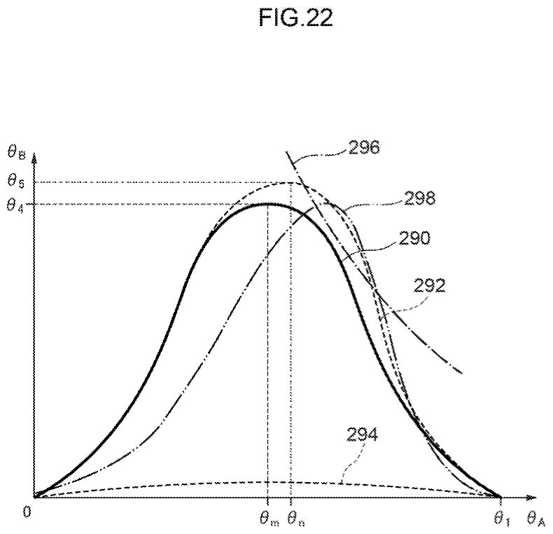

FIG. 22 illustrates an example of second output shaft relation angle maps defining rotation angles of the second output shaft 12A according to rotation angles of the first output shaft 11A in the second exemplary embodiment. The horizontal axis of FIG. 22 represents first output shaft rotation angles θ_{A} configuring rotation angles of the first output shaft 11A. and the vertical axis represents second output shaft rotation angles θ_{B} configuring rotation angles of the second output shaft 12A. The origin O in FIG. 22 represents a state in which the front passenger seal side wiper blade 36 is at the lower return position P2P. θ₁ in FIG. 22 represents a state in which the first output shaft 11A has rotated by a first predetermined rotation angle θ₁, and the front passenger seat side wiper blade 36 is at the upper return position P1P.

When the first absolute angle sensor 114 the first output shaft 11A of the first motor 11 starts to rotate, the microcomputer 58 compares the rotation angle of the first output shaft 11A detected by the first absolute angle sensor 114 against the second output shaft rotation angle map. This comparison is used to compute the second output shaft rotation angle θ_{B} corresponding to the first output shaft rotation angle θ_{A} detected by the first absolute angle sensor 114 using the angle indicated by the curve 290 in FIG. 22, and the rotation angle of the second output shaft 12A of the second motor 12 is controlled so as to become the computed second output shaft rotation angle θ_{B}. In FIG. 22, the curves 290, 292, 294, 298 illustrate three second output shaft rotation angle maps. The curve 290 represents rotation angles of the second output shaft 12A determined according to the first output shaft rotation angles θ_{A} when wiping the wiping range Z2. The curve 292 represents rotation angles of the second output shaft 12A determined according to the first output shaft rotation angles θ_{A} when wiping the wiping range Z7. The curve 294 represents rotation angles of the second output shaft 12A determined according to the first output shaft rotation angles θ_{A} when the front passenger seat side wiper arm 35 is not extended. The curve 298 is a modified example of the curve 292. The change ratio is lower than in the case of the curve 292, and the second output shaft rotation angles θ_{B} are set against the first output shaft rotation angles θ_{A} such that the leading end portion of the front passenger seat side wiper blade 36 travels beyond the outer edge portion of the windshield glass 1 and projects toward a vehicle roof 132. The curve 296 in FIG. 22 represents a boundary line as to whether or not the leading end portion of the front passenger seal side wiper blade 36 will travel beyond the outer edge portion of the windshield glass 1. The leading end portion of the front passenger seat side wiper blade 36 will travel beyond the outer edge portion of the windshield glass 1 in the region on the right side of the curve 296, and the leading end portion of the front passenger seat side wiper blade 36 will not travel beyond the outer edge portion of the windshield glass 1 in the region on the left side of the curve 296.

When employing the second output shaft rotation angle map represented by the curve 290, when the first output shaft rotation angle θ_{A} is an intermediate rotation angle θₘ between 0° and the first predetermined rotation angle θ₁, the rotation angle of forward rotation of the second output shaft 12A is at a maximum second predetermined rotation angle θ₄. When the rotation angle of forward rotation of the second output shaft 12A becomes the second predetermined rotation angle θ₄, the fifth axis L5 configuring the pivot point of the front passenger seat side wiper arm 35 is moved toward the top of the front passenger seat side of the windshield glass 1 (second position).

When employing the second output shaft rotation angle map represented by the curve 292, when the first output shaft rotation angle θ_{A} is an angle θn between the intermediate rotation angle θₘ and the first predetermined rotation angle θ₁, the rotation angle of forward rotation of the second output shaft 12A is at a maximum third predetermined rotation angle θ₅. As illustrated in FIG. 22, since the third predetermined rotation angle θ₅ is larger than the second predetermined rotation angle θ₄, when the rotation angle of forward rotation of the second output shaft 12A becomes the third predetermined rotation angle θ₅, the fifth axis L5 configuring the pivot point of the front passenger seat side wiper arm 35 is moved further toward the top of the front passenger seat side of the windshield glass 1 (than the second position).

When the front passenger seat side wiper arm 35 is not extended, namely when the second motor 12 is not rotating, the rotation angle of the second output shaft 12A is theoretically always at 0° regardless of the value of the first output shaft rotation angle θ_{A}. However, in live second exemplary embodiment, the link mechanism that moves the fifth axis L5 configuring the pivot point of the front passenger seat side wiper arm 35 might be affected by the drive force of the first motor 11 operating the driver's seat side wiper arm 17 and the front passenger seat side wiper arm 35 to-and-fro, such that in reality, the rotation angle of the second output shaft 12A might not always be at 0° regardless of the value of the first output shaft rotation angle θ_{A}.

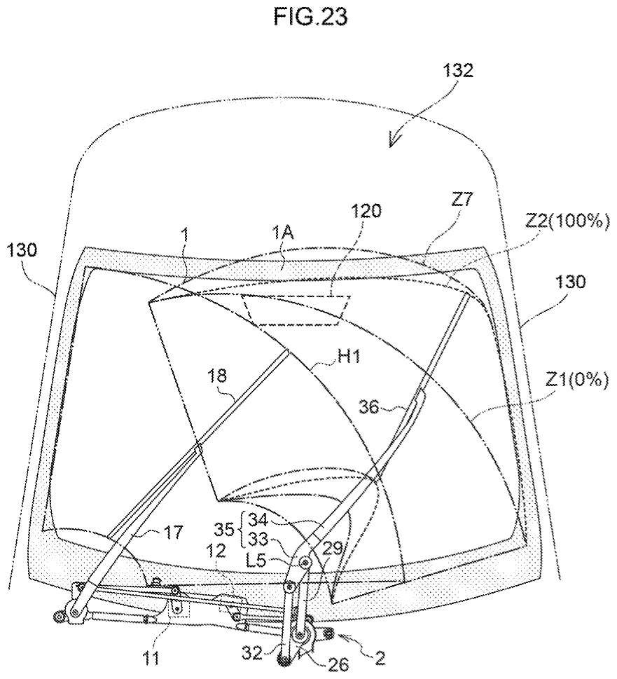

FIG. 23 is a schematic diagram illustrating an example of wiping ranges corresponding to the second output shaft rotation angle maps illustrated in FIG. 22. The wiping range Z1 is a wiping range when the front passenger seat side wiper arm 35 is not extended. The wiping range Z2 is a wiping range when employing the curve 290 illustrated in FIG. 22. The wiping range Z7 is a wiping range when employing the curve 292.

As illustrated in FIG. 22, the curve 292 diverges from the curve 290 just before the first output shaft rotation angle θ_{A} reaches the intermediate rotation angle θₘ between 0° and the first predetermined rotation angle θ₁. Since the curve 290 and the curve 292 are substantially the same as each other prior to diverging, even if employing the second output shaft rotation angle map represented by the curve 292, the leading end portion of the front passenger seat side wiper blade 36 wipes the windshield glass 1 without deviating toward a vehicle A-pillar side, similarly to when employing the second output shaft rotation angle map represented by the curve 290.

After diverging from the curve 290, on the curve 292 the rotation angle of forward rotation of the second output shaft 12A is at the maximum third predetermined rotation angle θ₅ when the first output shaft rotation angle θ_{A} is between the intermediate rotation angle θₘ and the first predetermined rotation angle θ₁. When employing the curve 292, the extension of the extension and retraction mechanism configured by the first drive lever 26, the second drive lever 29, the first following lever 32, and the arm head 33 is at a maximum when the front passenger seat side wiper blade 36 is positioned between a portion corresponding to the upper corner of the front passenger seat side of the windshield glass 1 and the upper return position P1P, specifically, between the vicinity of an intermediate position between the lower return position P2P and the upper return position P1P, and the upper return position P1P. Since the third predetermined rotation angle θ₅ is larger than the second predetermined rotation angle θ₄, the leading end portion of the front passenger seat side wiper blade 36 travels beyond the outer edge portion of the windshield glass 1 and projects toward the vehicle roof 132 side. As a result, the wiping range Z7 enables the upper side of the windshield glass 1 to be wiped over a wider range than the wiping range Z2. This enables water droplets present on the outer edge portion of the windshield glass 1 to be effectively wiped, enabling rain trickles to be prevented as a result.

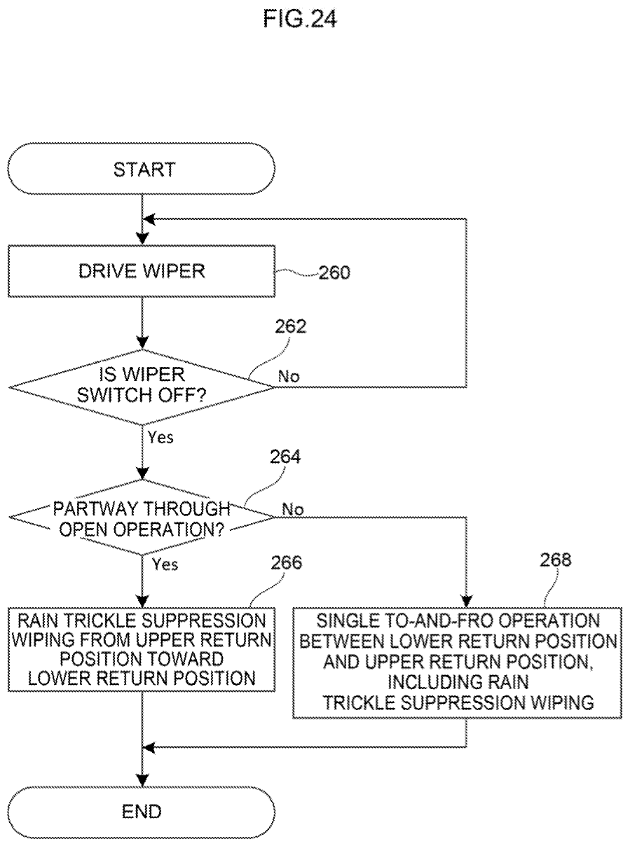

Explanation follows regarding control of the wiper system 100 according to the second exemplary embodiment. FIG. 24 is a flowchart illustrating an example of wiping change processing of the wiper system 100 according to the second exemplary embodiment. The processing in FIG. 24 starts when the wiper switch 50 has been switched ON. The wiper device 2 is driven at step 260.

At step 262, determination is made as to whether or not the wiper switch 50 has been switched OFF. Processing transitions to step 264 in cases in which determination is affirmative, and processing returns to step 260 in cases in which determination is negative, and the wiping operation is continued.

In cases in which determination is affirmative at step 262, at step 264, determination is made as to whether or not the front passenger seat side wiper blade 36 is performing an OPEN operation to move from the lower return position P2P toward the upper return position P1P. The determination of step 264 is performed based on variation in the rotation angle from the first absolute angle sensor 114.

In cases in which determination is affirmative at step 264, at step 266, the rotation angle of the second output shaft 12A is controlled employing the second output shaft rotation angle map corresponding to the curve 292 illustrated in FIG. 22 during a CLOSE operation in which the front passenger seat side wiper blade 36 moves from the upper return position P1P to the lower return position P2P. Rain trickle suppression wiping is performed to wipe the wiping range Z1 illustrated in FIG. 17 and FIG. 23, and then processing is ended.

In cases in which determination is negative at step 264, at step 268, a single to-and-fro wiping operation is performed that includes rain trickle suppression wiping between the lower return position P2P and the upper return position P1P. Specifically, during the OPEN operation in which the front passenger seat side wiper blade 36 wipes from the lower return position P2P to the upper return position P1P, the second output shaft rotation angle map corresponding to the curve 290 illustrated in FIG. 22 is employed to control the rotation angle of the second output shaft 12A, thereby wiping the wiping range Z2 illustrated in FIG. 17 and FIG. 23. Then, during the CLOSE operation in which the from passenger seat side wiper blade 36 moves from the upper return position P1P to the lower return position P2P, the second output shaft rotation angle map corresponding to the curve 292 illustrated in FIG. 22 is employed to control the rotation angle of the second output shaft 12A. thereby wiping the wiping range Z1 illustrated in FIG. 17 and FIG. 23 to perform the rain trickle suppression wiping, after which processing is ended.

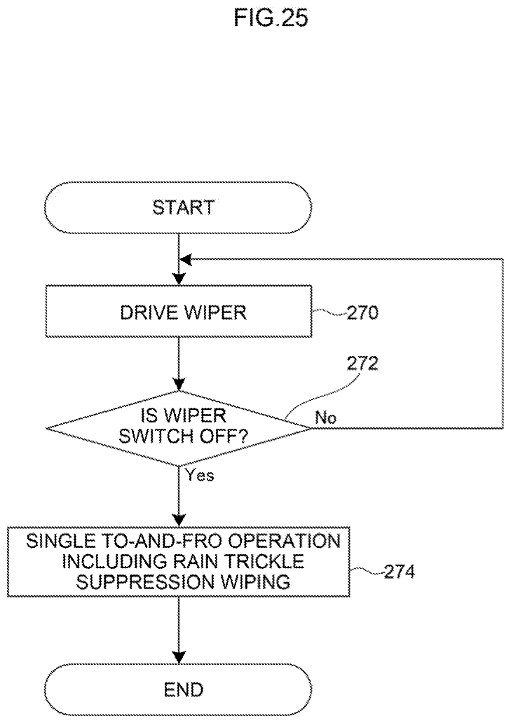

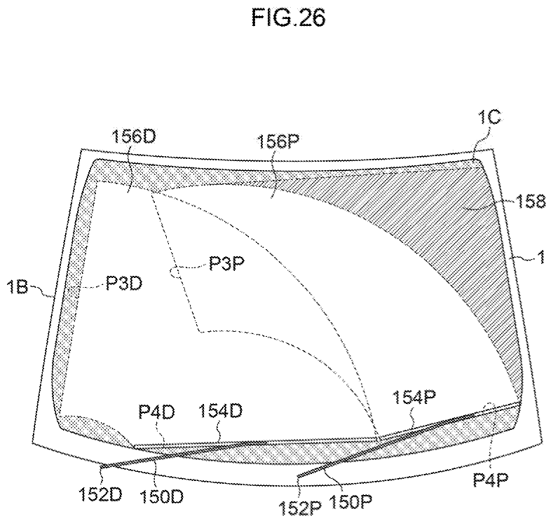

FIG. 25 is a flowchart illustrating a simplified example of wiping change processing of the wiper system 100 according to the second exemplary embodiment. The processing in FIG. 25 is started when the wiper switch 50 has been switched ON. The wiper device 2 is driven at step 270.

At step 272, determination is made as to whether or not the wiper switch 50 has been switched OFF. In cases in which determination is affirmative, processing transitions to step 274. and in cases in which determination is negative, processing returns to step 270 and the wiping operation is continued At step 274, a single to-and-fro wiping operation is performed between the lower return position P2P and the upper return position P1P, including rain trickle suppression wiping to wipe the wiping range Z7 illustrated in FIG. 17 and FIG. 23, and then processing is ended. In the wiping operation at step 274, during the OPEN operation in which the front passenger seat side wiper blade 36 wipes from the lower return position P2P to the upper return position P1P, the second output shaft rotation angle map corresponding the curve 290 illustrated in FIG. 22 is employed to control the rotation angle of the second output shaft 12A, thereby wiping the wiping range Z2 illustrated in FIG. 17 and FIG. 23. Then, during the CLOSE operation in which the front passenger seat side wiper blade 36 moves from the upper return position P1P to the lower return position P2P, the second output shaft rotation angle map corresponding to the curve 292 illustrated in FIG. 22 is employed to control the rotation angle of the second output shaft 12A, thereby wiping the wiping range Z1 illustrated in FIG. 17 and FIG. 23 to perform the rain trickle suppression wiping.

As described above, in the second exemplary embodiment, the second output shaft rotation angle map represented by the curve 292 is employed to remove water droplets from the outer edge portion of the windshield glass 1, enabling rain trickles to be prevented from running onto the windshield glass 1. Since the upper portion of the windshield glass 1 includes the functional area 120 where the rain sensor 76 and the onboard camera 94 are provided, preventing rain from trickling into the functional area 120 enables incorrect operation of the rain sensor 76 to be prevented and enables more appropriate functioning of the onboard camera 94. In the processing of FIG. 25, the rain trickle suppression wiping is performed when the wiper switch 50 has been switched OFF. However, the ram trickle suppression wiping may also be performed in cases in which the wiper switch 50 has been switched from the low speed operation mode selection position or the high speed operation mode selection position to the intermittent operation mode selection position. Since the front passenger seat side wiper blade 36 pauses at the lower return position in the intermittent operation mode, water droplets are removed from the outer edge portion of the windshield glass 1 by the rain trickle suppression wiping.

Since rain is more liable to trickle onto the windshield glass 1 when the vehicle has decelerated, the wiping range Z7 illustrated in FIG. 17 and FIG. 23 may be wiped in cases in which a reduction per unit time of the vehicle speed detected by the vehicle speed sensor 92 is a specific value or greater, thereby preventing rain from trickling into the functional area 120.

Moreover, the wiping range Z7 may be wiped in cases in which foreign material such as snow, ice, or mud is determined to be present on the windshield glass 1 based on the image data acquired by the onboard camera 94. Alternatively, in cases in which the GPS device 96 has detected that the vehicle is approaching an intersection and a vehicle steering angle detected by the steering angle sensor 98 is above a predetermined threshold value or the direction indicator switch has been operated, determination may be made that it is necessary to secure a broad field of view from the driver's seat, and the wiping range Z7 may be wiped. Furthermore, in cases in which an obstacle has been discovered ahead or to the side by the millimeter wave radar 102, the wiping range Z7 may be wiped in order to secure a broad field of view from the driver's seat.

Note that in the first exemplary embodiment and the second exemplary embodiment described above, the first output shaft 11A of the first motor 11 and the second output shaft 12A of the second motor 12 are controlled so as to be capable of forward and reverse (to-and-fro) rotation. However, there is no limitation thereto. For example, configuration may be made in which one of the first output shaft 11A or the second output shaft 12A rotates in a single direction.

Note that in the first exemplary embodiment and the second exemplary embodiment, although the driver's seat side wiper blade 18 and the front passenger seat side wiper blade 36 are moved between the upper return positions P1D, P1P and the lower return positions P2D, P2P by rotation of the first output shaft 11A of the first motor 11, there is no limitation thereto. For example, a structure may be applied in which a driver's seat side first motor and a front passenger seat side first motor are provided as the first motor 11, such that the driver's seat side wiper blade 18 is moved between the upper return position P1D and the lower return position P2D by rotation of the driver's seat side first motor, and the front passenger seat side wiper blade 36 is moved between the upper return position P1P and the lower return position P2P by rotation of the front passenger seat side first motor.

Note that in the first exemplary embodiment and the second exemplary embodiment, the extended front passenger seat side wiper arm 35 (front passenger seat side wiper blade 36) is controlled so as to retract on progression toward the upper return position P1P. However, there is no limitation thereto. For example, the front passenger seat side wiper arm 35 may be controlled so as to gradually extend as the front passenger seat side wiper blade 36 wipes from the lower return position P2P toward the upper return position P1P (on the outward journey).

Note that in the first exemplary embodiment and the second exemplary embodiment, explanation has been given regarding exemplary embodiments that employ the rotation angle of the first output shaft 11A of the first motor 11 and the rotation angle of the second output shaft 12A of the second motor 12. Alternatively, configuration may be made so as to employ a rotation position of the first output shaft 11A and a rotation position of the second output shaft 12A.

Note that in the first exemplary embodiment and the second exemplary embodiment, the first motor 11 and the second motor 12 are controlled so as to wipe the wiping range Z2 in circumstances in which a broad field of view needs to be secured on the from passenger seat side. However, an “automatic change changeover switch” may be separately provided to enable this control to be cancelled. Providing the automatic change changeover switch enables the wiping range Z1 to be wiped, without changing the wiping range even in circumstances in which a broad field of view needs to be secured on the front passenger seat side. Since the wiping range is not changed (the wiping range Z2 is not wiped) in cases in which a vehicle occupant considers it unnecessary to change the wiping range, distraction caused by the operation of the wiper device 2 can be suppressed. Although the position where the automatic change switchover switch is provided is not limited, the automatic change switchover switch is preferably provided at a position close to the driver, for example on the steering wheel.

The disclosures of Japanese Patent Application Nos. 2016-240533, and 2016-240534 are incorporated in their entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

1. A vehicle wiper device comprising:
a first motor that swings a wiper arm such that a wiper blade coupled to a leading end portion of the wiper arm wipes a windshield;
a second motor that extends or retracts an extension and retraction mechanism provided to the wiper arm in order to change a wiping range of the wiper blade; and
a controller that controls rotation of the first motor such that the first motor rotates at a rotation speed corresponding to a wiping speed, and that controls rotation of the second motor so as to extend or retract the extension and retraction mechanism by an extension or retraction amount corresponding to the wiping speed during a wiping operation.

2. The vehicle wiper device of claim 1, wherein the controller sets the wiping speed to a low speed or a high speed according to external circumstances.

3. The vehicle wiper device of claim 2, wherein the external circumstances include an amount of water on the windshield.

4. The vehicle wiper device of claim 1, wherein:
in cases in which the wiping speed is a low speed, the controller controls such that an extension amount of the extension and retraction mechanism is at a maximum when the wiper blade wipes a portion corresponding to an upper corner of the windshield; and
in cases in which the wiping speed is a high speed, the controller controls such that an extension amount of the extension and retraction mechanism when the wiper blade wipes the portion corresponding to the upper corner is smaller than the extension amount at the low speed, and such that an extension amount of the extension and retraction mechanism is at a maximum when the wiper blade is positioned between the portion corresponding to the upper corner and an upper return position.

5. The vehicle wiper device of claim 4, wherein in cases in which the wiping speed is a high speed, the controller controls such that an extension amount of the extension and retraction mechanism is at a maximum when the wiper blade is positioned in the vicinity of the upper return position.

6. The vehicle wiper device of claim 5, wherein in cases in which the wiping speed is a high speed, the controller controls so as to reverse a direction of the wiper blade at the upper return position while the second motor is in a driven state.

7. The vehicle wiper device of claim 1, wherein the controller controls rotation of the first motor and the second motor so as to project a rubber leading end portion of the wiper blade outside an outer edge portion of an upper portion of the windshield when the rubber leading end portion wipes a portion corresponding to the outer edge portion.

8. The vehicle wiper device of claim 7, wherein the controller controls so as to project the rubber leading end portion outside the outer edge portion at an upper portion side of the windshield, and so as not to project to the rubber leading end portion outside the outer edge portion at a side portion side of the windshield.

9. The vehicle wiper device of claim 7, wherein when stopping the wiper blade at a lower return position, the controller controls rotation of the first motor and the second motor so as to project the rubber leading end portion outside the outer edge portion during a wiping operation in a direction toward the lower return position after the wiper blade has been reversed in direction at an upper return position.

10. A vehicle wiper device control method comprising:
swinging a wiper arm such that a wiper blade coupled to a leading end portion of the wiper arm wipes a windshield;
extending or retracting an extension and retraction mechanism provided to the wiper arm in order to change a wiping range of the wiper blade; and
extending or retracting the extension and retraction mechanism by an extension or retraction amount corresponding to a wiping speed during a wiping operation.

11. The vehicle wiper device control method of claim 10, further comprising setting the wiping speed to a low speed or a high speed according to external circumstances.

12. The vehicle wiper device control method of claim 11, wherein the external circumstances include an amount of water on the windshield.

13. The vehicle wiper device control method of claim 10, wherein:
in cases in which the wiping speed is a low speed, an extension amount of the extension and retraction mechanism is at a maximum when the wiper blade wipes a portion corresponding to an upper corner of the windshield; and
in cases in which the wiping speed is a high speed, an extension amount of the extension and retraction mechanism when the wiper blade wipes the portion corresponding to the upper corner is smaller than the extension amount at the low speed, and an extension amount of the extension and retraction mechanism is at a maximum when the wiper blade is positioned between the portion corresponding to the upper corner and an upper return position.

14. The vehicle wiper device control method of claim 13, wherein in cases in which the wiping speed is a high speed, an extension amount of the extension and retraction mechanism is at a maximum when the wiper blade is positioned in the vicinity of the upper return position.

15. The vehicle wiper device control method of claim 14, wherein in cases in which the wiping speed is a high speed, the wiper blade is reversed in direction at the upper return position in an extended state of the extension and retraction mechanism.

16. The vehicle wiper device control method of claim 10, wherein a rubber leading end portion of the wiper blade is projected outside an outer edge portion of an upper portion of the windshield when the rubber leading end portion wipes a portion corresponding to the outer edge portion.

17. The vehicle wiper device control method of claim 16, wherein the rubber leading end portion is projected outside the outer edge portion on an upper portion side of the windshield, and is not projected outside the outer edge portion on a side portion side of the windshield.

18. The vehicle wiper device control method of claim 16, wherein when stopping the wiper blade at a lower return position, the rubber leading end portion is projected outside the outer edge portion during a wiping operation in a direction toward the lower return position after the wiper blade has been reversed in direction at an upper return position.
